(19) United States
(12) Patent Application Publication
(10) Pub. No.: US 2026/0169879 A1
(43) Pub. Date: Jun. 18, 2026

(54) FAULT TOLERANT QUEUE PROCESSING WITH RELIABLE ORDERING

(71) Applicant: Coinbase, Inc., Oakland, CA (US)

(72) Inventors: Chandresh Kantilal Kapadia, Newark, CA (US); Matthew Martyn Harper, Santa Cruz, CA (US); Yu Zhang, Bellevue, WA (US); Andrew James Gundlach, Charlotte, NC (US)

(21) Appl. No.: 18/985,007

(22) Filed: Dec. 17, 2024

(51) Int. Cl. G06F 11/30; G06F 11/14

(52) U.S. Cl. CPC G06F 11/3006; G06F 11/14

(57) ABSTRACT

Methods, systems, and devices for data management are described. A processor may receive, via an event stream, a request to process an event associated with an account. The processor may query, for retrieving a block status of the account, a data store associated with a dead letter queue (DLQ). In response to determining that the block status is a first status, the processor may attempt to process the event. In response to determining that the block status is a second status indicating that events associated with the account are being blocked, the processor may send the request to the DLQ. A DLQ processor may attempt to process events in the DLQ. The DLQ processor may update, after successfully processing an event in the DLQ, a stream offset of the event stream to correspond to the event and update a block status of an account associated with the event.

### FIELD OF TECHNOLOGY

The present disclosure relates generally to data management, including techniques for fault tolerant queue processing with reliable ordering.

### BACKGROUND

Blockchains and related technologies may be employed to support recordation of ownership of digital assets, such as cryptocurrencies, fungible tokens, non-fungible tokens (NFTs), and the like. Generally, peer-to-peer networks support transaction validation and recordation of transfer of such digital assets on blockchains. Various types of consensus mechanisms may be implemented by the peer-to-peer networks to confirm transactions and to add blocks of transactions to the blockchain networks. Example consensus mechanisms include the proof-of-work consensus mechanism implemented by the Bitcoin network and the proof-of-stake mechanism implemented by the Ethereum network. Some nodes of a blockchain network may be associated with a digital asset exchange, which may be accessed by users to trade digital assets or trade a fiat currency for a digital asset.

### BRIEF DESCRIPTION OF THE DRAWINGS

FIGS. 1 and 2 illustrate examples of computing environments that support fault tolerant queue processing with reliable ordering in accordance with aspects of the present disclosure.

FIGS. 3 and 4 show examples of flow diagrams that support fault tolerant queue processing with reliable ordering in accordance with aspects of the present disclosure.

FIG. 5 shows an example of a process flow that supports fault tolerant queue processing with reliable ordering in accordance with aspects of the present disclosure.

FIG. 6 shows a block diagram of an apparatus that supports fault tolerant queue processing with reliable ordering in accordance with aspects of the present disclosure.

FIG. 7 shows a block diagram of an event processor that supports fault tolerant queue processing with reliable ordering in accordance with aspects of the present disclosure.

FIG. 8 shows a diagram of a system including a device that supports fault tolerant queue processing with reliable ordering in accordance with aspects of the present disclosure.

FIG. 9 shows a block diagram of an apparatus that supports fault tolerant queue processing with reliable ordering in accordance with aspects of the present disclosure.

FIG. 10 shows a block diagram of a DLQ event processor that supports fault tolerant queue processing with reliable ordering in accordance with aspects of the present disclosure.

FIG. 11 shows a diagram of a system including a device that supports fault tolerant queue processing with reliable ordering in accordance with aspects of the present disclosure.

FIGS. 12 through 15 show flowcharts illustrating methods that support fault tolerant queue processing with reliable ordering in accordance with aspects of the present disclosure.

### DETAILED DESCRIPTION

In some computing environments, a service may process events in an event stream in accordance with an ordering guarantee. For example, a processor of the service may receive events in an incoming event stream and perform one or more operations to process the events in a sequential manner. Events may involve one or more accounts of the service, such as transfers of assets between different accounts of the service, withdrawals from an account of the service to another account external to the service, or the like. In some cases, events may involve operations on a blockchain network, such as operations involving crypto tokens, operations validated by computing nodes and stored on a blockchain ledger of the blockchain network, or the like.

In order to prevent inconsistencies between events, the processor may process events in the event stream in a sequential order (e.g., with an ordering guarantee). As an example, a first event in the event stream may involve a buy of a first amount of a first crypto token by a first blockchain address, and a second event in the event stream after the first event may involve a trade between the first blockchain address and a second blockchain address of the first amount of the first crypto token for a second amount of the second crypto token. Without processing the first event, the first blockchain address may not have an adequate amount of the first crypto token to perform the trade with the second blockchain address. That is, because an event in the event stream may depend in some manner on a prior event, such as involve a same account (e.g., a same blockchain address), the processor may not process events independently of one another or skip events that fail to process.

Because the processor is required to maintain an ordering guarantee, when the processor fails to process an event in the event stream, other events within the event stream may be delayed until the event is skipped (e.g., invalidated, canceled, etc.) or resolved via manual intervention. Such delays may affect events in the event stream that are associated with high priority accounts of the service, as all events for the service may be part of a same event stream (e.g., regardless of being associated with different accounts, priorities, etc.). Additionally, because the service is required to maintain the ordering guarantee, events may not simply be moved to a dead letter queue (DLQ) for offline processing. For example, if a first event is moved to the DLQ and a second event involving a same account remains in a queue for the processor (e.g., a main processor), the second event may be processed prior to the first event, leading to an inconsistency.

To reduce delay associated with event processing in examples where an ordering of events in the event stream is required, the service may use a DLQ in accordance with block statuses and a stream offset. For example, the service may account for an ordering of events within the event stream by moving events that have failed to process as well as events associated with accounts having a blocked status to the DLQ. A main processor may assign the blocked status to an account when moving events to the DLQ such that subsequent events associated with the same account are also moved to the DLQ and the ordering guarantee is maintained. Additionally, the main processor may update a stream offset stored at a data store associated with the DLQ when moving an event to the DLQ. A DLQ processor (e.g., a processor different than the main processor that processes events in the DLQ) may attempt to process events in the DLQ. The DLQ processor may update a stream offset of the event stream (e.g., different than the stored stream offset) after successfully processing events and, when the stream offset matches the stream offset stored at the data store (e.g., when the DLQ processor has processed all events in the DLQ corresponding to a given account), remove a block status. By moving events associated with blocked addresses to the DLQ, the main processor may continue processing other events in the event stream while maintaining the ordering guarantee.

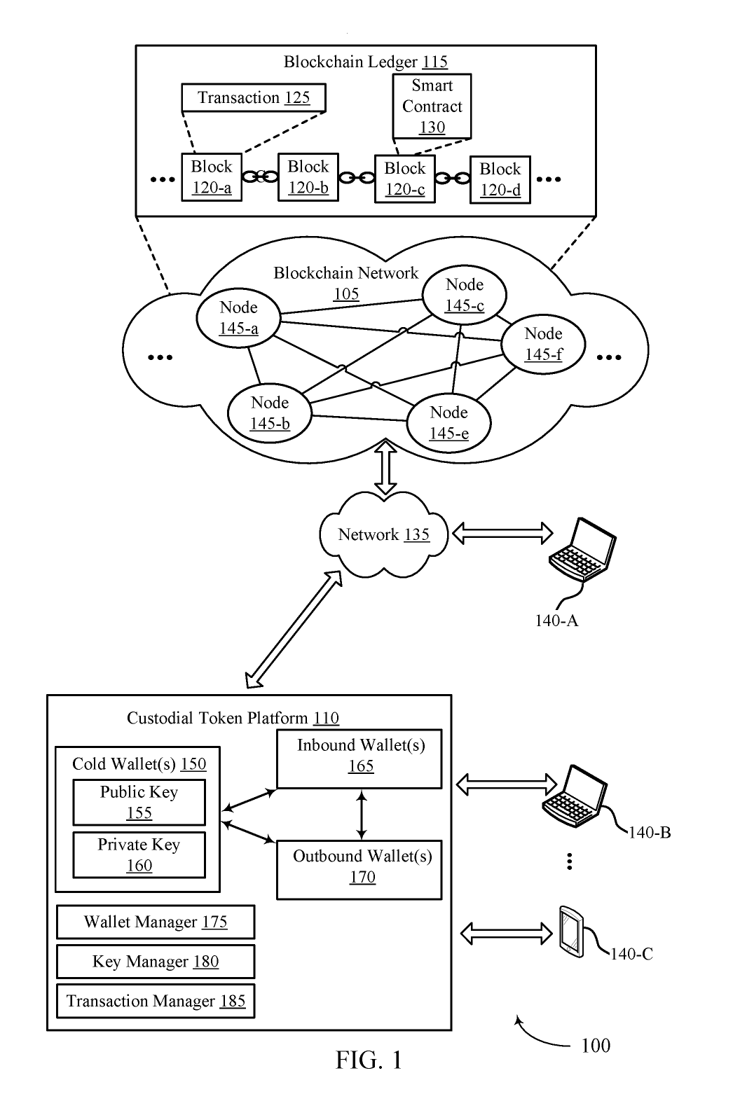

FIG. 1 illustrates an example of a computing environment 100 that supports fault tolerant queue processing with reliable ordering in accordance with aspects of the present disclosure. The computing environment 100 may include a blockchain network 105 that supports a blockchain ledger 115, a custodial token platform 110, and one or more computing devices 140, which may be in communication with one another via a network 135.

The network 135 may allow the one or more computing devices 140, one or more nodes 145 of the blockchain network 105, and the custodial token platform 110 to communicate (e.g., exchange information) with one another. The network 135 may include aspects of one or more wired networks (e.g., the Internet), one or more wireless networks (e.g., cellular networks), or any combination thereof. The network 135 may include aspects of one or more public networks or private networks, as well as secured or unsecured networks, or any combination thereof. The network 135 also may include any quantity of communications links and any quantity of hubs, bridges, routers, switches, ports or other physical or logical network components.

Nodes 145 of the blockchain network 105 may generate, store, process, verify, or otherwise use data of the blockchain ledger 115. The nodes 145 of the blockchain network 105 may represent or be examples of computing systems or devices that implement or execute a blockchain application or program for peer-to-peer transaction and program execution. For example, the nodes 145 of the blockchain network 105 support recording of ownership of digital assets, such as cryptocurrencies, fungible tokens, non-fungible tokens (NFTs), and the like, and changes in ownership of the digital assets. The digital assets may be referred to as tokens, coins, crypto tokens, or the like. The nodes 145 may implement one or more types of consensus mechanisms to confirm transactions and to add blocks (e.g., blocks 120-a, 120-b, 120-c, and so forth) of transactions (or other data) to the blockchain ledger 115. Example consensus mechanisms include a proof-of-work consensus mechanism implemented by the Bitcoin network and a proof-of-stake consensus mechanism implemented by the Ethereum network.

When a device (e.g., the computing device 140-a, 140-b, or 140-c) associated with the blockchain network 105 executes or completes a transaction associated with a token supported by the blockchain ledger, the nodes 145 of the blockchain network 105 may execute a transfer instruction that broadcasts the transaction (e.g., data associated with the transaction) to the other nodes 145 of the blockchain network 105, which may execute the blockchain application to verify the transaction and add the transaction to a new block (e.g., the block 120-d) of a blockchain ledger (e.g., the blockchain ledger 115) of transactions after verification of the transaction. Using the implemented consensus mechanism, each node 145 may function to support maintaining an accurate blockchain ledger 115 and prevent fraudulent transactions.

The blockchain ledger 115 may include a record of each transaction (e.g., a transaction 125) between wallets (e.g., wallet addresses) associated with the blockchain network 105. Some blockchains may support smart contracts, such as smart contract 130, which may be an example of a sub-program that may be deployed to the blockchain and executed when one or more conditions defined in the smart contract 130 are satisfied. For example, the nodes 145 of the blockchain network 105 may execute one or more instructions of the smart contract 130 after a method or instruction defined in the smart contract 130 is called by another device. In some examples, the blockchain ledger 115 is referred to as a blockchain distributed data store.

A computing device 140 may be used to input information to or receive information from the computing system custodial token platform 110, the blockchain network 105, or both. For example, a user of the computing device 140-a may provide user inputs via the computing device 140-a, which may result in commands, data, or any combination thereof being communicated via the network 135 to the computing system custodial token platform 110, the blockchain network 105, or both. Additionally, or alternatively, a computing device 140-a may output (e.g., display) data or other information received from the custodial token platform 110, the blockchain network 105, or both. A user of a computing device 140-a may, for example, use the computing device 140-a to interact with one or more user interfaces (e.g., graphical user interfaces (GUIs)) to operate or otherwise interact with the custodial token platform 110, the blockchain network 105, or both.

A computing device 140 and/or a node 145 may be a stationary device (e.g., a desktop computer or access point) or a mobile device (e.g., a laptop computer, tablet computer, or cellular phone). In some examples, a computing device 140 and/or a node 145 may be a commercial computing device, such as a server or collection of servers. And in some examples, a computing device 140 and/or a node 145 may be a virtual device (e.g., a virtual machine).

Some blockchain protocols may have layer two and layer two functionality, and each layer may support or utilize different tokens. Layer one may refer to the underlying main blockchain architecture, and layer one solutions are improvements directly integrated into the codebase of a cryptocurrency’s main blockchain. Layer one solutions, on the other hand, are built on top of layer one and may interact with the main blockchain but have their own architecture. Layer two solutions may support offload of processing from the main blockchain (layer one) to improve scalability and speed while retaining the robust security of the main chain. Additionally, smart contracts implemented on the blockchain networks may support different types of tokens, and the code of the smart contracts may control how tokens are spent, who can spend the tokens, and other conditions for transfer. Additionally, one or more smart contracts may support a decentralized application (“Dapp”) that facilitate various types of functionality. Accordingly, various types of tokens may be supported by a blockchain network.

The custodial token platform 110 may support exchange or trading of digital assets, fiat currencies, or both by users of the custodial token platform 110. The custodial token platform 110 may be accessed via website, web application, or applications that are installed on the one or more computing devices 140. The custodial token platform 110 may be configured to interact with one or more types of blockchain networks, such as the blockchain network 105, to support digital asset purchase, exchange, deposit, and withdrawal.

For example, users may create accounts associated with the custodial token platform 110 such as to support purchasing of a digital asset via a fiat currency, selling of a digital asset via fiat currency, or exchanging or trading of digital assets. A key management service (e.g., a key manager) of the custodial token platform 110 may create, manage, or otherwise use private keys that are associated with user wallets and internal wallets. For example, if a user wishes to withdraw a token associated with the user account to an external wallet address, key manager 180 may sign a transaction associated with a wallet of the user, and broadcast the signed transaction to nodes 145 of the blockchain network 105, as described herein. In some examples, a user does not have direct access to a private key associated with a wallet or account supported or managed by the custodial token platform 110. As such, user wallets of the custodial token platform 110 may be referred to non-custodial wallets or non-custodial addresses.

The custodial token platform 110 may create, manage, delete, or otherwise use various types of wallets to support digital asset exchange. For example, the custodial token platform 110 may maintain one or more internal cold wallets 150. The internal cold wallets 150 may be an example of an offline wallet, meaning that the cold wallet 150 is not directly coupled with other computing systems or the network 135 (e.g., at all times). The cold wallet 150 may be used by the custodial token platform 110 to ensure that the custodial token platform 110 is secure from losing assets via hacks or other types of unauthorized access and to ensure that the custodial token platform 110 has enough assets to cover any potential liabilities. The one or more cold wallets 150, as well as other wallets of the blockchain network 105 may be implemented using public key cryptography, such that the cold wallet 150 is associated with a public key 155 and a private key 160. The public key 155 may be used to publicly transact via the cold wallet 150, meaning that another wallet may enter the public key 155 into a transaction such as to move assets from the wallet to the cold wallet 150. The private key 160 may be used to verify (e.g., digitally sign) transactions that are transmitted from the cold wallet 150, and the digital signature may be used by nodes 145 to verify or authenticate the transaction. Other wallets of the custodial token platform 110 and/or the blockchain network 105 may similarly use aspects of public key cryptography.

The custodial token platform 110 may also create, manage, delete, or otherwise use inbound wallets 165 and outbound wallets 170. For example, a wallet manager 175 of the custodial token platform 110 may create a new inbound wallet 165 for each user or account of the custodial token platform 110 or for each inbound transaction (e.g., deposit transaction) for the custodial token platform 110. In some examples, the custodial token platform 110 may implement techniques to move digital assets between wallets of the digital asset exchange platform. Assets may be moved based on a schedule, based on asset thresholds, liquidity requirements, or a combination thereof. In some examples, movements or exchanges of assets internally to the custodial token platform 110 may be “off-chain” meaning that the transactions associated with the movement of the digital asset are not broadcast via the corresponding blockchain network (e.g., blockchain network 105). In such cases, the custodial token platform 110 may maintain an internal accounting (e.g., ledger) of assets that are associated with the various wallets and/or user accounts.

As used herein, a wallet, such as inbound wallets 165 and outbound wallets 170 may be associated with a wallet address, which may be an example of a public key, as described herein. The wallets may be associated with a private key that is used to sign transactions and messages associated with the wallet. A wallet may also be associated with various user interface components and functionality. For example, some wallets may be associated with or leverage functionality for transmitting crypto tokens by allowing a user to enter a transaction amount, a receiver address, etc. into a user interface and clicking or activating a UI component such that the transaction is broadcast via the corresponding blockchain network via a node (e.g., a node 145) associated with the wallet. As used herein, “wallet” and “address” may be used interchangeably.

In some cases, the custodial token platform 110 may implement a transaction manager 185 that supports monitoring of one or more blockchains, such as the blockchain ledger 115, for incoming transactions associated with addresses managed by the custodial token platform 110 and creating and broadcasting on-blockchain transactions when a user or customer sends a digital asset (e.g., a withdrawal). For example, the transaction manager 185 may monitor the addressees of the customers for transfer of layer one or layer two tokens supported by the blockchain ledger 115 to the addresses managed by the custodial token platform 110. As another example, when a user is withdrawing a digital asset, such as a layer one or layer two token, to an external wallet (e.g., an address that is not managed by the custodial token platform 110 or an address for which the custodial token platform 110 does not have access to the associated private key), the transaction manager 185 may create and broadcast the transaction to one or more other nodes 145 of the blockchain network 105 in accordance with the blockchain application associated with the blockchain network 105. As such, the transaction manager 185, or an associated component of the custodial token platform 110 may function as a node 145 of the blockchain network 105.

As described herein, the custodial token platform may implement and support various wallets including the inbound wallets 165, the outbound wallets 170, and the cold wallets 150. Further, the custodial token platform 110 may implement techniques to maintain and manage balances of the various wallets. In some examples, the balances of the various wallets are configured to support security and liquidity. For example, the custodial token platform 110 may implement transactions that move crypto tokens between the inbound wallets 165 and the outbound wallets 170. These transactions may be referred to as “flush” transactions and may occur on a periodic or scheduled basis.

As described herein, various transactions may be broadcast to the blockchain ledger 115 to cause transfer of crypto tokens, to call smart contracts, to deploy smart contracts etc. In some examples, these transactions may also be referred to as messages. That is, the custodial token platform 110 may broadcast a message to the blockchain network 105 to cause transfer of tokens between wallets managed by the custodial token platform 110 to an external wallet, to deploy a smart contract (e.g., a self-executing program), or to call a smart contract.

The custodial token platform 110 may process events in an event stream, including events involving operations on the blockchain network 105. For example, the custodial token platform 110 may receive requests to perform operations via the blockchain network 105 (e.g., cryptographic operations) involving blockchain addresses, validation by one or more nodes, and storage on the blockchain ledger 115. The custodial token platform 110 may receive and process the requests sequentially such that operations are included in the blockchain ledger 115 in a correct order. However, in some cases, the custodial token platform 110 may fail to process a request (e.g., fail to process an event, such as perform an operation on the blockchain network 105). The custodial token platform 110 may block processing of other requests in a queue after failing to process the request, which may be associated with latency.

Alternatively, as described herein, the custodial token platform 110 may move requests that fail to process at a main processor to a DLQ and mark accounts (e.g., blockchain addresses, wallet addresses, or user accounts of the custodial token platform 110) as blocked. Marking the accounts as blocked may cause subsequent requests involving the accounts to be automatically moved to the DLQ such that an order is maintained between events on the blockchain ledger 115. For example, moving requests involving blocked accounts to the DLQ may prevent an operation involving a blocked account from being broadcast and stored in the blockchain ledger 115 prior to processing of an earlier requested operation that involved the blocked account. Additionally, the custodial token platform 110 (e.g., the main processor and the DLQ of the custodial token platform 110) may maintain a stored stream offset that indicates a point within the event stream where an event failed to process and is compared to a stream offset of the event stream updated by a DLQ processor to reflect events processed within the DLQ. The stream offset may indicate when events processed in the DLQ have caught up with the event stream such that a block status for an account may be removed.

By processing events via the main processor and the DLQ, using blocked statuses, and maintaining a stream offset, techniques described herein support improved processing of events in an event queue involving an ordering guarantee. For example, techniques described herein reduce processing delay and improve throughput for events in an event stream that are behind one or more other events that fail to process. That is, the main processor may continue to process events in the event stream that are absent accounts having blocked statuses such that failure to process an event within the stream does not preclude others from being processed. Additionally, by moving events to the DLQ that are associated with blocked accounts automatically, the main processor may improve a throughput (e.g., a quantity of events processed over a time duration).

In some examples, by moving events to the DLQ in accordance with the blocked statuses, techniques described herein support an ordering guarantee for events associated with same accounts. That is, the main processor may process events involving a first user account in an order in which they are received via the event stream by, if an event associated with the first user account fails to process, moving all other events associated with the first user account to the DLQ. Additionally, in the DLQ, events may be processed automatically (e.g., without manual intervention), which may reduce latency in examples where events fail to process in the main processor. Accordingly, techniques described herein support accurate (e.g., with respect to an ordering guarantee) and efficient processing of events in an event stream via a main processor and a DLQ processor. Aspects of DLQ processing are described as being implemented by the custodial token platform 110 of FIG.1, but it should be understood that the DLQ processing techniques described herein may be implemented in other platforms or system (e.g., platforms or systems unrelated to token management).

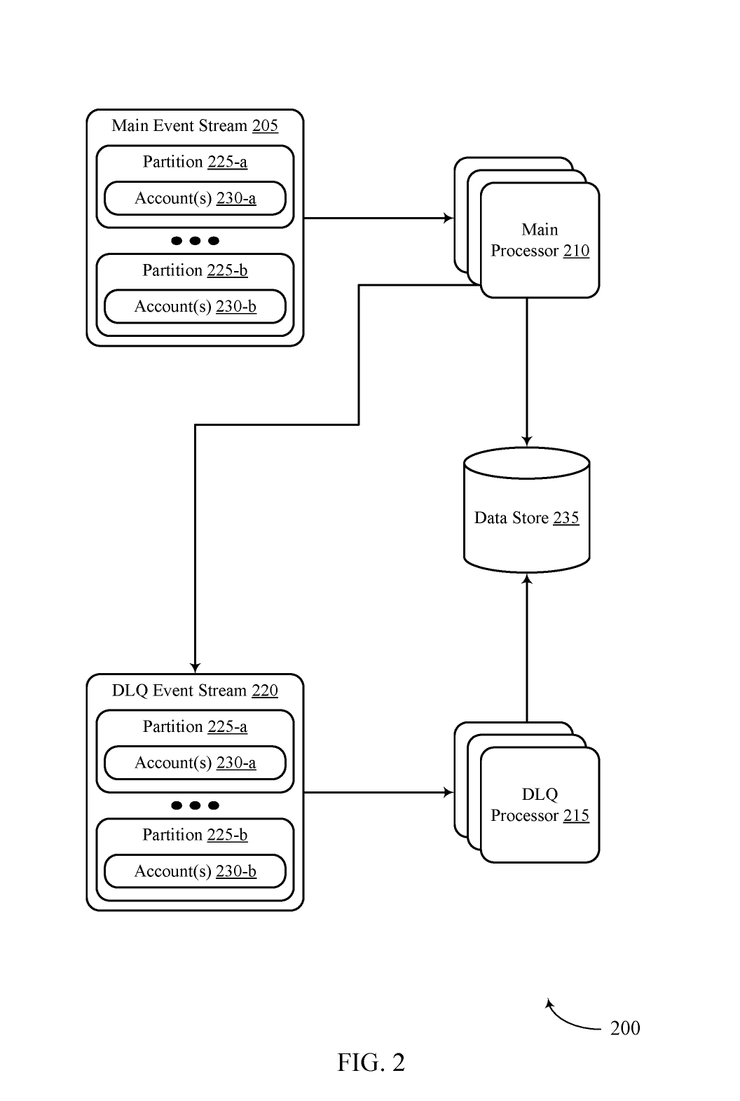

FIG. 2 shows an example of a computing environment 200 that supports fault tolerant queue processing with reliable ordering in accordance with aspects of the present disclosure. The computing environment 200 may implement or be implemented by aspects of the computing environment 100 as described with reference to FIG. 1. For example, the computing environment 200 may run on one or more computing devices 140 that communicate via a network 135. As an example, the main processor 210 and the DLQ processor 215 may be components or systems of same or different computing devices 140. Additionally, or alternatively, the computing environment 200 may be implemented by one or more servers or computing systems, such as servers or computing systems supporting an enterprise application environment.

A main event stream 205 may include one or more events having an order of occurrence. In some examples, the main event stream 205 may include topics, partitions, or both. For example, the main event stream 205 may include one or more topics corresponding to different categories of events, such as events related to exchanging crypto tokens (e.g., in the context of the custodial token platform 110). Within a topic, the main event stream 205 may include one or more partitions. In the example of FIG. 2, the main event stream 205 may include a single topic having a partition 225-a and a partition 225-b. The partitions may correspond to respective accounts. For example, partition 225-a may correspond to account(s) 230-a and partition 225-b may correspond to account(s) 230-b. The main event stream 205 may include the partitions such that events of same accounts are routed to a same main processor.

For example, the main processor 210 may include multiple individual processors that correspond to respective partitions in the main event stream 205 (e.g., or a topic within the main event stream 205). As an example, the main processor 210 may include a first processor that manages events in the partition 225-a and a second processor that manages events in the partition 225-b. Put another way, the main processor 210 may include multiple individual processors that are assigned to respective accounts or sets of accounts, such as a first processor assigned to events related to account(s) 230-a and a second processor assigned to events related to account(s) 230-b.

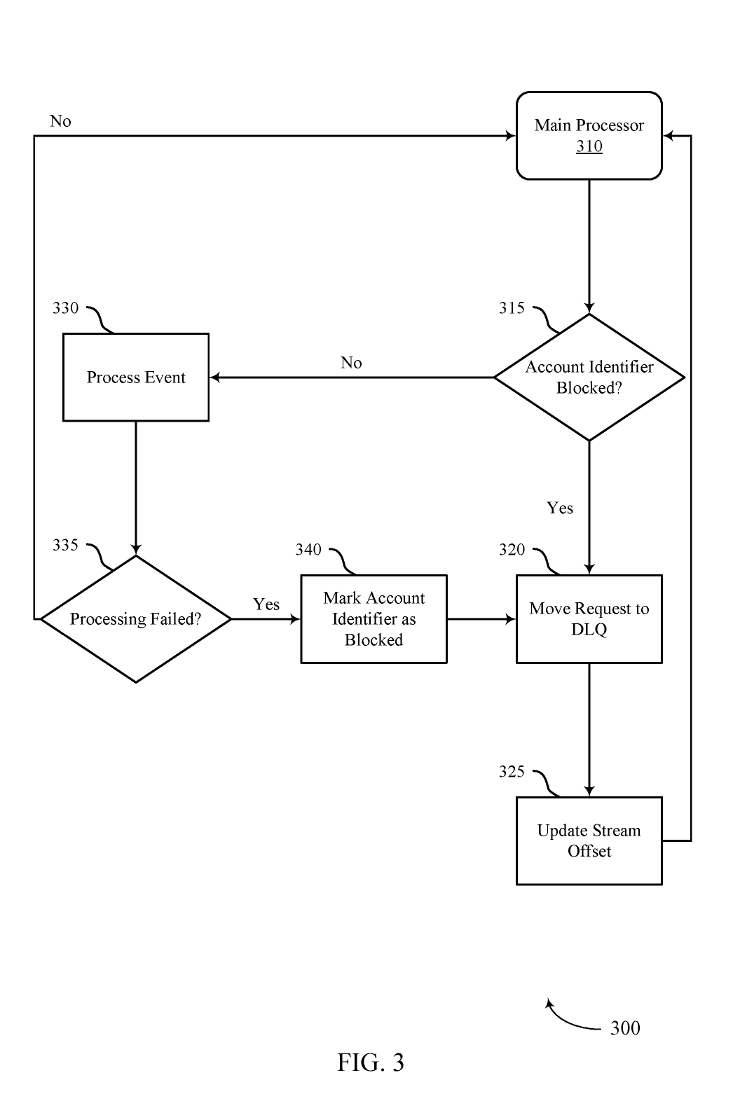

The main processor 210 may receive requests (e.g., one after another) to process events in the main event stream 205. For example, the main processor 210 may receive a request to process an event in the main event stream 205. The main processor 210 may reallocate events to the DLQ event stream 220 when the main processor 210 fails to process the event or when the event is associated with an account having a blocked status. The main processor 210 may retrieve the block status from a data store 235 to determine whether an account associated with an incoming request is blocked. Operations of the main processor 210 may be described in greater detail elsewhere herein, including with reference to FIG. 3.

The DLQ processor 215 may receive requests (e.g., one after another) to process events in the DLQ event stream 220. Similarly to the main event stream 205, the DLQ event stream 220 may include partitions corresponding to one or more accounts or sets of accounts. For example, the DLQ event stream 220 may include same partitions corresponding to same accounts as the main event stream, such as the partition 225-a corresponding to account(s) 230-a and the partition 225-b corresponding to account(s) 230-b. Additionally, the DLQ processor 215 may include multiple individual processors that correspond to respective partitions in the DLQ event stream 220 (e.g., or partitions in a topic within the DLQ event stream 220). That is, the DLQ processor 215 may include multiple individual processors that are assigned to respective partitions (e.g., including events associated with one or more accounts), such as a first processor assigned to events within the partition 225-a (e.g., related to account(s) 230-a) and a second processor assigned to events within the partition 225-b (e.g., related to account(s) 230-b).

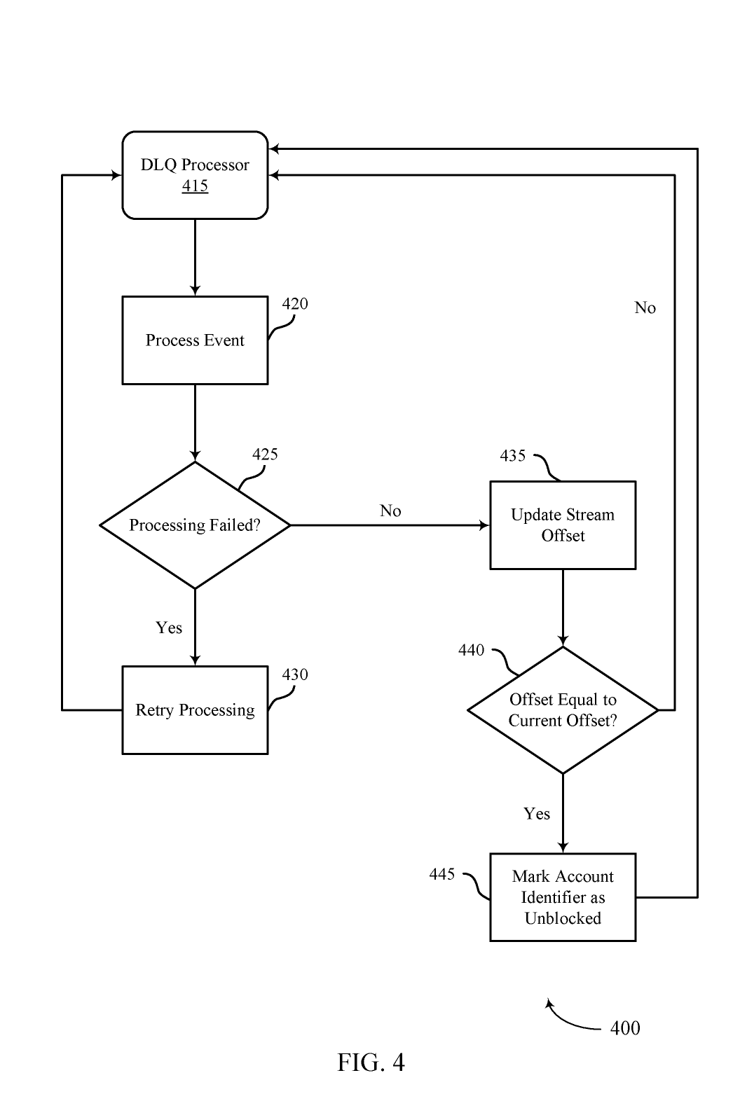

The DLQ processor 215 may attempt to process events in the DLQ event stream 220 and, if events are successfully processed, update a stream offset of the main event stream 205. For example, the DLQ processor 215 may update the stream offset to indicate a status of event processing by the DLQ processor 215 relative to events failed by the main processor 210. The DLQ processor 215 may update a block status of an account via the data store 235 when the stream offset indicates that no events related to the account remain in the DLQ event stream 220. Aspects related to the DLQ processor 215 may be described in greater detail elsewhere herein, including with reference to FIG. 4.

The data store 235 may store block statuses of accounts. For example, the data store 235 may store identifiers of accounts that are mapped to statuses indicating whether accounts associated with the identifiers are blocked from processing at the main processor 210 and are to be moved to the DLQ event stream 220. Additionally, the data store 235 may store a stream offset updated by the main processor 210 to mark events the main processor 210 failed to process. The DLQ processor 215 may access the data store 235 to compare the stream offset updated by the main processor 210 to a stream offset of the main event stream 205 updated by the DLQ processor 215 when events in the DLQ event stream 220 are successfully processed. The data store 235 may be an example of an in-memory not only structured query language (NoSQL) data structure store, an external cache, such as a remote dictionary server (redis) store, or the like.

In some examples, updates to the data store 235 that stores stream offsets of failed entries may be atomic. For example, the DLQ processor 215 may update the stream offset in the data store 235 after an operation is complete (e.g., entirely complete, not partially complete). That is, updates to the data store 235 may happen based on an indivisibility of an operation (e.g., an operation being executed in its entirety, such as rather than partially). Updating the data store 235 atomically may support consistency between the main processor 210, the DLQ processor 215, and the data store 235. For example, by updating an event when it is entirely complete (e.g., rather than partially), the DLQ processor 215 may ensure that an updated stream offset is accurate and will not change (e.g., later fail processing at the DLQ processor 215, as an example).

FIG. 3 shows an example of a flow diagram 300 that supports fault tolerant queue processing with reliable ordering in accordance with aspects of the present disclosure. The flow diagram 300 may implement or be implemented by the computing environment 100, the computing environment 200, or both. For example, the flow diagram 300 may include operations performed by a main processor 310, which may correspond to the main processor 210 as described with reference to FIG. 2.

The main processor 310 may receive a request to process an event in an event stream, such as an event in the main event stream 205 as described with reference to FIG. 2. Prior to attempting to process the event, at 315, the main processor 310 may determine whether an account identifier of an account associated with the event is blocked. As used herein, an account being “associated with” an event may be defined as the event involving the account in some manner. As an example, an account may be associated with an event if the event involves a transfer of an amount of a crypto token from the account (e.g., from a blockchain address associated with the account), an exchange of tokens by the account, or the like. To determine whether the account identifier is blocked, the main processor 310 may query a data store, such as the data store 235 as described with reference to FIG. 2. For example, the main processor 310 may query the data store 235 with the account identifier, and a response to the query may indicate whether the account identifier is blocked (e.g., has a blocked status).

If the main processor 310 determines that the account identifier is blocked, at 320, the main processor 310 may move the request to the DLQ. For example, the main processor 310 may reallocate the request to process the event to a DLQ event stream to be processed by a DLQ processor, such as the DLQ event stream 220 processed by the DLQ processor 215 as described with reference to FIG. 2. Additionally, at 325, the main processor 310 may update a stream offset. For example, the main processor 310 may update the stream offset in a data store to be a latest offset. Put another way, the main processor 310, after moving a request to the DLQ (e.g., “failing” an event in a main event stream), may indicate a most recent point within the event stream at which a movement of an event to the DLQ (e.g., a failure) occurred by updating the stream offset to correspond to the event. The stream offset indicating a most recent failed event may enable identification of whether events in the DLQ have caught up to events in the main event stream and allow the DLQ processor to remove blocked statuses for accounts.

At 330, if the main processor 310 determines that the account identifier is not blocked, the main processor 310 may attempt to process the event. Attempting to process the event may include attempting to perform a requested operation, such as an operation on a blockchain network. At 335, the main processor 310 may determine whether processing failed. In some examples, determining whether processing failed may include determining whether an amount of processing attempts exceeds a preconfigured threshold. That is, the main processor 310 may receive an indication of a threshold amount of processing attempts that defines “failure” of processing. If processing fails, at 340, the main processor 310 may mark the account identifier as blocked. For example, the main processor 310 may update a status of the account identifier to blocked (e.g., from unblocked to blocked) after failing to process the event associated with the account having the account identifier. Updating the status may include updating the status at a data store, such as at the data store 235 as described with reference to FIG. 2. After marking the account identifier as blocked, the main processor 310 may move the request to the DLQ at 320 and update the stream offset at 325.

If processing is successful or if an event is moved to the DLQ and a stream offset updated, the main processor 310 may attempt to process a next event in the event stream. That is, the main processor 310 may continue processing events sequentially in the event stream according to the flow diagram 300 after addressing an event by successfully processing the event or by moving the event to the DLQ and updating a stream offset.

FIG. 4 shows an example of a flow diagram 400 that supports fault tolerant queue processing with reliable ordering in accordance with aspects of the present disclosure. The flow diagram 400 may implement or be implemented by the computing environment 100, the computing environment 200, the flow diagram 300, or any combination thereof. For example, the flow diagram 400 may include operations performed by a DLQ processor 415, which may correspond to the DLQ processor 215 as described with reference to FIG. 2. Additionally, the flow diagram 400 may involve events that are moved to the DLQ processor 415 by the main processor, such as in accordance with the operation at 320 of FIG. 3.

The DLQ processor 415 may, at 420, attempt to process an event. For example, the DLQ processor 415 may receive a request to process an event that is first in a DLQ (e.g., in a DLQ event stream 220) and attempt to process the event (e.g., immediately, without checking a status, etc.). At 425, the DLQ processor 415 may determine whether processing failed. If processing fails, at 430, the DLQ processor 415 may retry processing the event. That is, the DLQ processor 415 may attempt to process the event until the event is successfully processed.

At 435, after successfully processing the event, the DLQ processor 415 may update a stream offset to be a current offset. For example, the DLQ processor 415 may update a stream offset of a main event stream to a main processor to indicate that the event was successfully processed via the DLQ processor 415. After updating the stream offset, at 440, the DLQ processor 415 may determine whether a stored offset is equal to a current offset. For example, the DLQ processor 415 may determine whether the event that was successfully processed corresponds to an event most recently failed by a main processor by comparing the stream offset updated by the DLQ processor 415 at 435 to a stored stream offset updated by the main processor after sending events to the DLQ (e.g., at 325). If the stream offset updated by the DLQ processor 415 at 435 matches the stored stream offset, the match in offsets may indicate that the DLQ processor 415 has processed all events for a given account and the account may now be processed via the main processor (e.g., rather than being sent to the DLQ processor 415). For example, at 445, if the stream offset equals the current offset, the DLQ processor 415 may mark the account identifier as unblocked. Alternatively, if the stream offset is not equal to the current offset, the DLQ processor 415 may move to a next event in the DLQ without marking the account identifier of the successfully processed event as unblocked.

After evaluating whether the stream offset is equal to a current offset and, in some examples, updating a block status of an account identifier, the DLQ processor 415 may continue to process a next event in the DLQ. That is, the DLQ processor 415 may continue processing events sequentially in the DLQ according to the flow diagram 400 after processing an event, updating the event stream, and, in some examples, updating a block status of an account identifier.

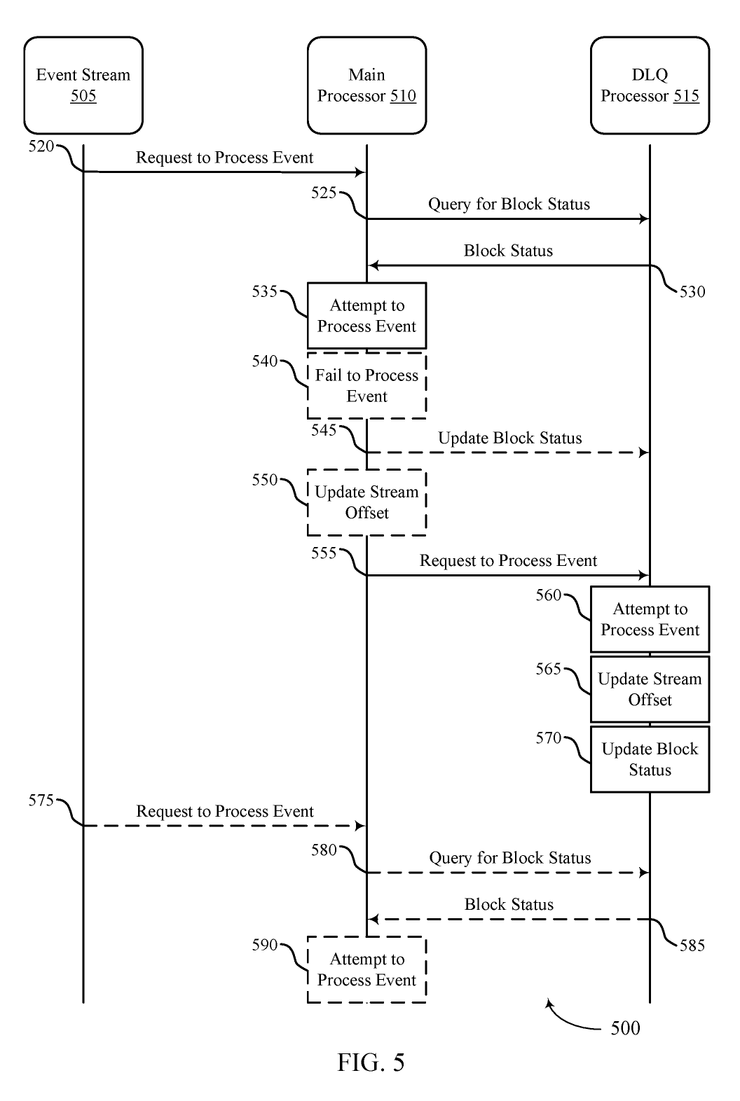

FIG. 5 shows an example of a process flow 500 that supports fault tolerant queue processing with reliable ordering in accordance with aspects of the present disclosure. The process flow 500 may implement or be implemented by the computing environment 100, the computing environment 200, the flow diagram 300, the flow diagram 400, or any combination thereof. For example, the process flow 500 may include an event stream 505, a main processor 510, and a DLQ processor 515, which may be examples of the corresponding devices or systems as described with reference to FIGS. 2 through 4.

Alternative examples of the following may be implemented, where some operations are performed in a different order than described or are not performed at all. In some examples, operations may include additional features not mentioned below, or further operations may be added. Although the event stream 505, the main processor 510, and the DLQ processor 515 are shown performing the operations of the process flow 500, some aspects of some operations may also be performed by one or more other components.

At 520, the main processor 510 may receive a request to process an event of an event stream 505. For example, the main processor 510 may receive, via an event stream 505, a request to process an event, the event being associated with an account. The event stream 505 may be an example of a main event stream 205 and the account may be an example of one of the accounts(s) 230-a or the account(s) 230-b as described with reference to FIG. 2. The event stream 505 may include multiple events, and the event stream 505 may include multiple partitions, each partition associated with one or more accounts, a respective main processor, and a respective DLQ. The processing operations described herein with respect to the main processor 510 and the DLQ processor 515 may refer to operations at respective main processors and respective DLQ processors.

At 525, the main processor 510 may query the DLQ processor 515 for a block status. For example, the main processor 510 may query, for retrieving a block status associated with the account, a data store associated with a DLQ using an identifier associated with the account, the block status indicating whether events associated with the account are being blocked for processing. In other words, the main processor 510 may request a block status of the account prior to processing the event associated with the account. The data store may be an example of the data store 235 as described with reference to FIG. 2. In the example of FIG. 5, the main processor 510 querying the DLQ processor 515 may refer to querying the data store associated with the DLQ processor 515.

At 530, the main processor 510 may obtain the block status. For example, the DLQ processor 515 may receive, to retrieve the block status associated with the account, a query using the identifier associated with the account, the block status indicating whether events associated with the account are being blocked for processing. The DLQ processor 515 may transmit, based on the identifier, a response to the query including the block status of the account.

At 535, the main processor 510 may attempt to process the event. For example, in response to determining that the block status is a first status (e.g., unblocked), the main processor 510 may attempt to process the event. In some examples, the event may include an operation associated with a blockchain address on a blockchain network. In such examples, processing the event may include broadcasting one or more messages to the blockchain network configured to execute the operation. Put another way, the main processor 510 may broadcast one or more messages to the blockchain network that cause one or more computing nodes to validate the operation and store the operation on a blockchain ledger of the blockchain network.

At 540, the main processor 510 may fail to process the event. For example, the main processor 510 may fail to process the event after determining that the block status is the first status. In some examples, the block status may be updated after failure of a threshold quantity of processing attempts. The threshold quantity of processing attempts may be configured via a user input to a service associated with the main processor 510. For example, the main processor 510 may obtain one or more user inputs indicative of the threshold quantity of processing attempts, where the main processor 510 fails to process the event at 540 in accordance with the threshold quantity of processing attempts.

In examples in which the main processor 510 fails to process the event, at 545, the main processor 510 may update, at the data store associated with the DLQ, the block status of the identifier of the account associated with the event that failed to process. That is, the main processor 510 may update the block status to the second status to indicate that the events associated with the account are being blocked. Additionally, at 550, the main processor 510 may update a stream offset. For example, the main processor 510 may update, after failing to process the event, a stream offset stored at the data store associated with the DLQ (e.g., in an in-memory NoSQL data structure store) to correspond to the event.

At 555, the main processor 510 may transmit a request to the DLQ processor 515 to process the event. For example, in response to determining that the block status is a second status (e.g., blocked), the main processor 510 may send the request to the DLQ based on the second status indicating that events associated with the account are being blocked. In other words, the main processor 510 may move the event to the DLQ (e.g., without attempting processing) when the status indicates that the account is blocked.

At 560, the DLQ processor 515 may attempt to process the event. For example, the DLQ processor 515 may attempt to process one or more events in a DLQ, where the one or more events are received from a main processor 510. That is, when the main processor 510 sends the request to the DLQ, the event may be entered within a DLQ event stream that is processed in an order of receipt (e.g., from an event received a longest time ago to a shortest time ago) by the DLQ processor 515. In examples in which the event includes an operation associated with a blockchain address on the blockchain network, processing the operation may include broadcasting one or more messages to the blockchain network configured to execute the operation.

At 565, the DLQ processor 515 may update a stream offset. For example, the DLQ processor 515 may update, after successfully processing an event of the one or more events in the DLQ, a stream offset of an event stream 505 that provides, to the main processor 510, a stream of events including the event, the stream offset updated to correspond to the successfully processed event. That is, the DLQ processor 515 may update the stream offset to indicate that the event was successfully processed.

At 570, the DLQ processor 515 may update a block status. For example, the DLQ processor 515 may update a block status associated with an identifier of an account associated with the event that was successfully processed. In some examples, updating the block status of the identifier from a first status (e.g., blocked) to a second status (e.g., unblocked) based on the updated stream offset corresponding to a current offset at the main processor. That is, the DLQ processor 515 may remove a blocked status from an account based on the stream offset updated at 565 matching (e.g., being equal to) an offset stored at the data store associated with the DLQ (e.g., in an in-memory NoSQL data structure store) by the main processor 510 at 550 after failing to process the event at 540.

In some examples, the DLQ processor 515 may skip one or more events in the DLQ. For example, the DLQ processor 515 may skip a second event of the one or more events in the DLQ based on a configuration that indicates to skip events associated with a second account, the second event being associated with the second account. The configuration may indicate to skip events associated with the second account in accordance with a user of the service including the main processor 510 and the DLQ processor 515 manually addressing an issue with the second account that is causing processing of events associated with the second account to fail.

At 575, the main processor 510 may receive a request to process an event of the event stream 505. For example, the main processor 510 may receive, after sending the request to the DLQ at 555, a second request to process a second event, the second event being associated with a second account. After receiving the second request, at 580, the main processor 510 may query for a block status. That is, the main processor 510 may query for the block status of the second account using a second identifier associated with the second account. At 585, the main processor 510 may obtain the block status. At 590, the main processor 510 may attempt to process an event. For example, in response to determining that a second block status of the second account is the first status (e.g., unblocked), the main processor 510 may process the second event. The main processor 510 may attempt to process the second event simultaneously to the DLQ processor 515 attempting to process the event at 560. That is, the main processor may continue to process other events of the event stream 505 after sending the request to process the event to the DLQ processor 515 at 555.

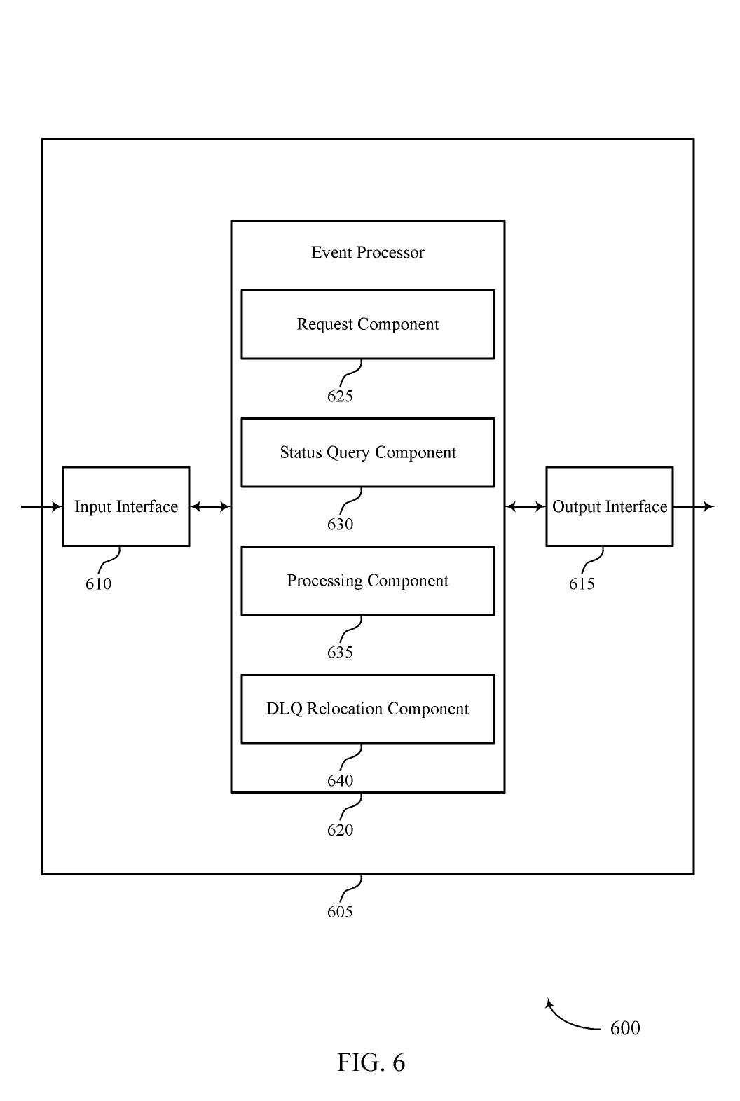

FIG. 6 shows a block diagram 600 of a system 605 that supports fault tolerant queue processing with reliable ordering in accordance with aspects of the present disclosure. The system 605 may include an input interface 610, an output interface 615, and an event processor 620. The system 605, or one or more components of the system 605 (e.g., the input interface 610, the output interface 615, the event processor 620), may include at least one processor, which may be coupled with at least one memory, to support the described techniques. Each of these components may communicate, directly or indirectly, with one another (e.g., via one or more buses, communications links, communications interfaces, or any combination thereof).

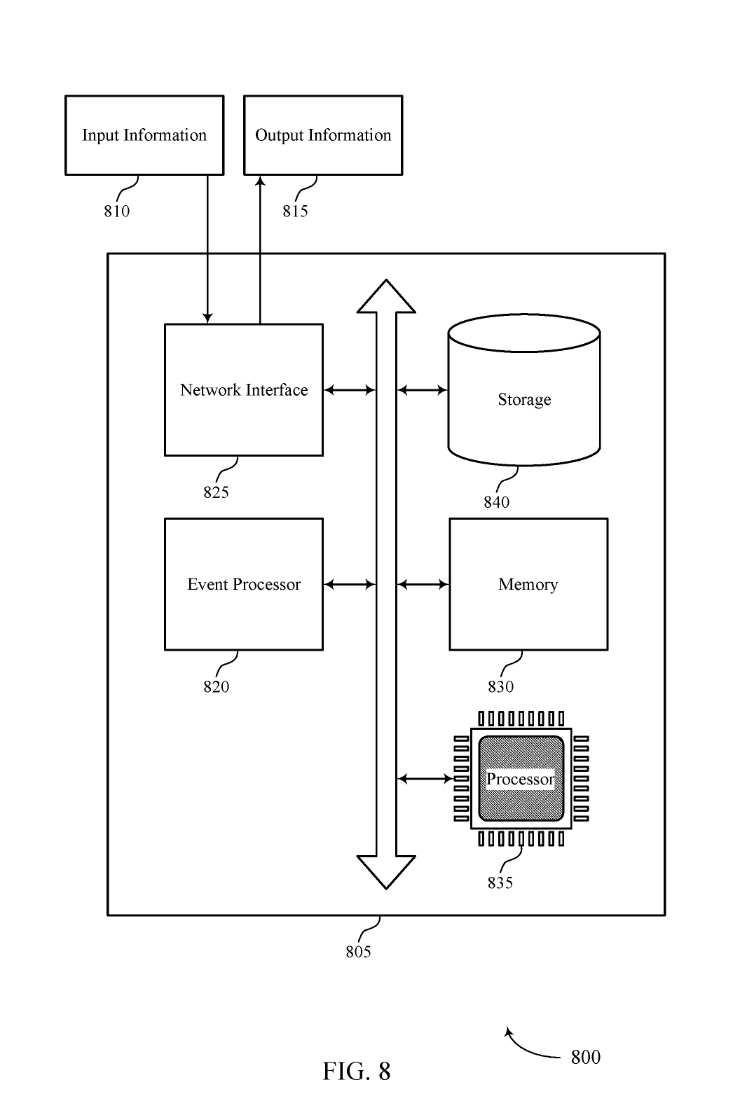

The input interface 610 may manage input signaling for the system 605. For example, the input interface 610 may receive input signaling (e.g., messages, packets, data, instructions, commands, transactions, or any other form of encoded information) from other systems or devices. The input interface 610 may send signaling corresponding to (e.g., representative of or otherwise based on) such input signaling to other components of the system 605 for processing. For example, the input interface 610 may transmit such corresponding signaling to the event processor 620 to support fault tolerant queue processing with reliable ordering. In some cases, the input interface 610 may be a component of a network interface 825 as described with reference to FIG. 8.

The output interface 615 may manage output signaling for the system 605. For example, the output interface 615 may receive signaling from other components of the system 605, such as the event processor 620, and may transmit such output signaling corresponding to (e.g., representative of or otherwise based on) such signaling to other systems or devices. In some cases, the output interface 615 may be a component of a network interface 825 as described with reference to FIG. 8.

For example, the event processor 620 may include a request component 625, a status query component 630, a processing component 635, a DLQ relocation component 640, or any combination thereof. In some examples, the event processor 620, or various components thereof, may be configured to perform various operations (e.g., receiving, monitoring, transmitting) using or otherwise in cooperation with the input interface 610, the output interface 615, or both. For example, the event processor 620 may receive information from the input interface 610, send information to the output interface 615, or be integrated in combination with the input interface 610, the output interface 615, or both to receive information, transmit information, or perform various other operations as described herein.

The request component 625 may be configured as or otherwise support a means for receiving, via an event stream, a request to process an event, the event being associated with an account. The status query component 630 may be configured as or otherwise support a means for querying, for retrieving a block status associated with the account, a data store associated with a DLQ using an identifier associated with the account, the block status indicating whether events associated with the account are being blocked for processing. The processing component 635 may be configured as or otherwise support a means for in response to determining that the block status is a first status, attempting to process the event. The DLQ relocation component 640 may be configured as or otherwise support a means for in response to determining that the block status is a second status, sending the request to the DLQ based at least in part on the second status indicating that events associated with the account are being blocked.

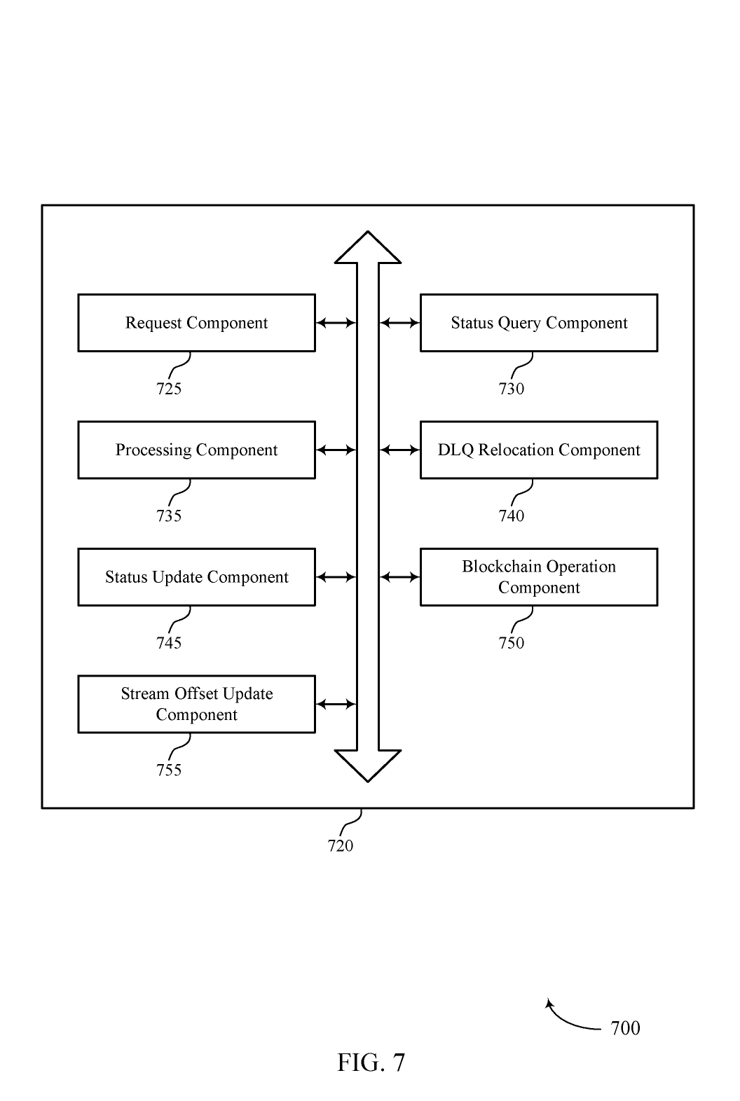

FIG. 7 shows a block diagram 700 of an event processor 720 that supports fault tolerant queue processing with reliable ordering in accordance with aspects of the present disclosure. The event processor 720 may be an example of aspects of an event processor or an event processor 620, or both, as described herein. The event processor 720, or various components thereof, may be an example of means for performing various aspects of fault tolerant queue processing with reliable ordering as described herein. For example, the event processor 720 may include a request component 725, a status query component 730, a processing component 735, a DLQ relocation component 740, a status update component 745, a blockchain operation component 750, a stream offset update component 755, or any combination thereof. Each of these components may communicate, directly or indirectly, with one another (e.g., via one or more buses, communications links, communications interfaces, or any combination thereof).

The request component 725 may be configured as or otherwise support a means for receiving, via an event stream, a request to process an event, the event being associated with an account. The status query component 730 may be configured as or otherwise support a means for querying, for retrieving a block status associated with the account, a data store associated with a DLQ using an identifier associated with the account, the block status indicating whether events associated with the account are being blocked for processing. The processing component 735 may be configured as or otherwise support a means for in response to determining that the block status is a first status, attempting to process the event. The DLQ relocation component 740 may be configured as or otherwise support a means for in response to determining that the block status is a second status, sending the request to the DLQ based at least in part on the second status indicating that events associated with the account are being blocked.

In some examples, the processing component 735 may be configured as or otherwise support a means for failing to process the event after determining that the block status is the first status. In some examples, the status update component 745 may be configured as or otherwise support a means for updating, at the data store associated with the DLQ, the block status of the identifier of the account associated with the event that failed to process, wherein the block status is updated to the second status to indicate that the events associated with the account are being blocked.

In some examples, the block status is updated after failure of a threshold quantity of processing attempts.

In some examples, the stream offset update component 755 may be configured as or otherwise support a means for updating, after failing to process the event, a stream offset of the event stream to correspond to the event.

In some examples, the request component 725 may be configured as or otherwise support a means for receiving, after sending the request to the DLQ, a second request to process a second event, the second event being associated with a second account. In some examples, the processing component 735 may be configured as or otherwise support a means for in response to determining that a second block status of the second account is the first status, processing the second event.

In some examples, the event comprises an operation associated with a blockchain address on a blockchain network, and the blockchain operation component 750 may be configured as or otherwise support a means for broadcasting one or more messages to the blockchain network configured to execute the operation.

In some examples, a plurality of events are received from the event stream that comprises a plurality of partitions, each partition associated with one or more accounts, a respective main processor, and a respective DLQ.

FIG. 8 shows a diagram of a system 800 including a system 805 that supports fault tolerant queue processing with reliable ordering in accordance with aspects of the present disclosure. The system 805 may be an example of or include components of a system 605 as described herein. The system 805 may include components for bi-directional voice and data communications including components for transmitting and receiving communications, such as an event processor 820, an input information 810, an output information 815, a network interface 825, at least one memory 830, at least one processor 835, and a storage 840. Each of these components may communicate, directly or indirectly, with one another (e.g., via one or more buses, communications links, communications interfaces, or any combination thereof).

The network interface 825 may enable the system 805 to exchange information (e.g., input information 810, output information 815, or both) with other systems or devices (not shown). For example, the network interface 825 may enable the system 805 to connect to a network (e.g., a network 135 as described herein). The network interface 825 may include one or more wireless network interfaces, one or more wired network interfaces, or any combination thereof.

Memory 830 may include RAM, ROM, or both. The memory 830 may store computer-readable, computer-executable software including instructions that, when executed, cause at least one processor 835 to perform various functions described herein, such as functions supporting fault tolerant queue processing with reliable ordering. In some cases, the memory 830 may contain, among other things, a basic input/output system (BIOS), which may control basic hardware or software operation such as the interaction with peripheral components or devices. In some cases, the memory 830 may be an example of aspects of one or more components of a custodial token platform 110 as described with reference to FIG. 1. The memory 830 may be an example of a single memory or multiple memories. For example, the system 805 may include one or more memories 830.

The processor 835 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 835 may be configured to execute computer-readable instructions stored in at least one memory 830 to perform various functions (e.g., functions or tasks supporting fault tolerant queue processing with reliable ordering). Though a single processor 835 is depicted in the example of FIG. 8, it is to be understood that the system 805 may include any quantity of one or more of processors 835 and that a group of processors 835 may collectively perform one or more functions ascribed herein to a processor, such as the processor 835. The processor 835 may be an example of a single processor or multiple processors. For example, the system 805 may include one or more processors 835.

Storage 840 may be configured to store data that is generated, processed, stored, or otherwise used by the system 805. In some cases, the storage 840 may include one or more HDDs, one or more SDDs, or both. In some examples, the storage 840 may be an example of a single database, a distributed database, multiple distributed databases, a data store, a data lake, or an emergency backup database. In some examples, the storage 840 may be an example of one or more components described with reference to FIG. 1.

For example, the event processor 820 may be configured as or otherwise support a means for receiving, via an event stream, a request to process an event, the event being associated with an account. The event processor 820 may be configured as or otherwise support a means for querying, for retrieving a block status associated with the account, a data store associated with a DLQ using an identifier associated with the account, the block status indicating whether events associated with the account are being blocked for processing. The event processor 820 may be configured as or otherwise support a means for in response to determining that the block status is a first status, attempting to process the event. The event processor 820 may be configured as or otherwise support a means for in response to determining that the block status is a second status, sending the request to the DLQ based at least in part on the second status indicating that events associated with the account are being blocked.

By including or configuring the event processor 820 in accordance with examples as described herein, the system 805 may support techniques for reduced latency associated with event processing while maintaining event ordering.

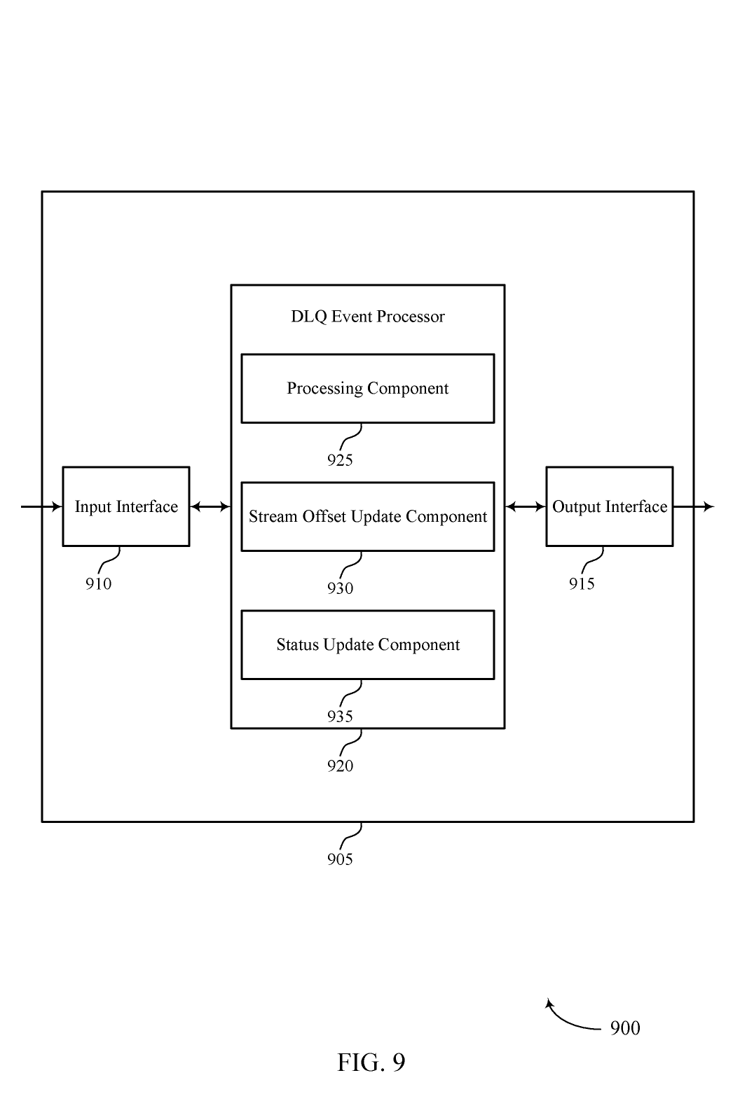

FIG. 9 shows a block diagram 900 of a system 905 that supports fault tolerant queue processing with reliable ordering in accordance with aspects of the present disclosure. The system 905 may include an input interface 910, an output interface 915, and a DLQ event processor 920. The system 905, or one or more components of the system 905 (e.g., the input interface 910, the output interface 915, the DLQ event processor 920), may include at least one processor, which may be coupled with at least one memory, to support the described techniques. Each of these components may communicate, directly or indirectly, with one another (e.g., via one or more buses, communications links, communications interfaces, or any combination thereof).

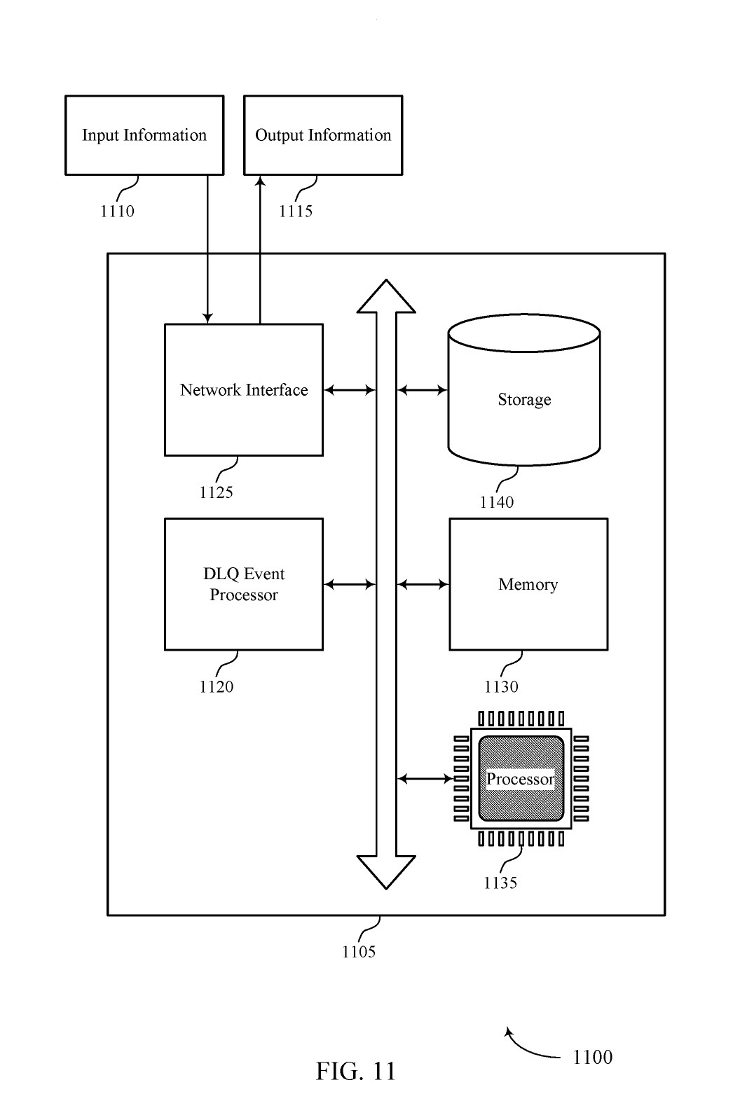

The input interface 910 may manage input signaling for the system 905. For example, the input interface 910 may receive input signaling (e.g., messages, packets, data, instructions, commands, transactions, or any other form of encoded information) from other systems or devices. The input interface 910 may send signaling corresponding to (e.g., representative of or otherwise based on) such input signaling to other components of the system 905 for processing. For example, the input interface 910 may transmit such corresponding signaling to the DLQ event processor 920 to support fault tolerant queue processing with reliable ordering. In some cases, the input interface 910 may be a component of a network interface 1125 as described with reference to FIG. 11.

The output interface 915 may manage output signaling for the system 905. For example, the output interface 915 may receive signaling from other components of the system 905, such as the DLQ event processor 920, and may transmit such output signaling corresponding to (e.g., representative of or otherwise based on) such signaling to other systems or devices. In some cases, the output interface 915 may be a component of a network interface 1125 as described with reference to FIG. 11.

For example, the DLQ event processor 920 may include a processing component 925, a stream offset update component 930, a status update component 935, or any combination thereof. In some examples, the DLQ event processor 920, or various components thereof, may be configured to perform various operations (e.g., receiving, monitoring, transmitting) using or otherwise in cooperation with the input interface 910, the output interface 915, or both. For example, the DLQ event processor 920 may receive information from the input interface 910, send information to the output interface 915, or be integrated in combination with the input interface 910, the output interface 915, or both to receive information, transmit information, or perform various other operations as described herein.

The processing component 925 may be configured as or otherwise support a means for attempting to process one or more events in a DLQ, wherein the one or more events are received from a main processor. The stream offset update component 930 may be configured as or otherwise support a means for updating, after successfully processing an event of the one or more events in the DLQ, a stream offset of an event stream that provides, to the main processor, a stream of events comprising the event, the stream offset updated to correspond to the successfully processed event. The status update component 935 may be configured as or otherwise support a means for updating a block status associated with an identifier of an account associated with the event that was successfully processed.

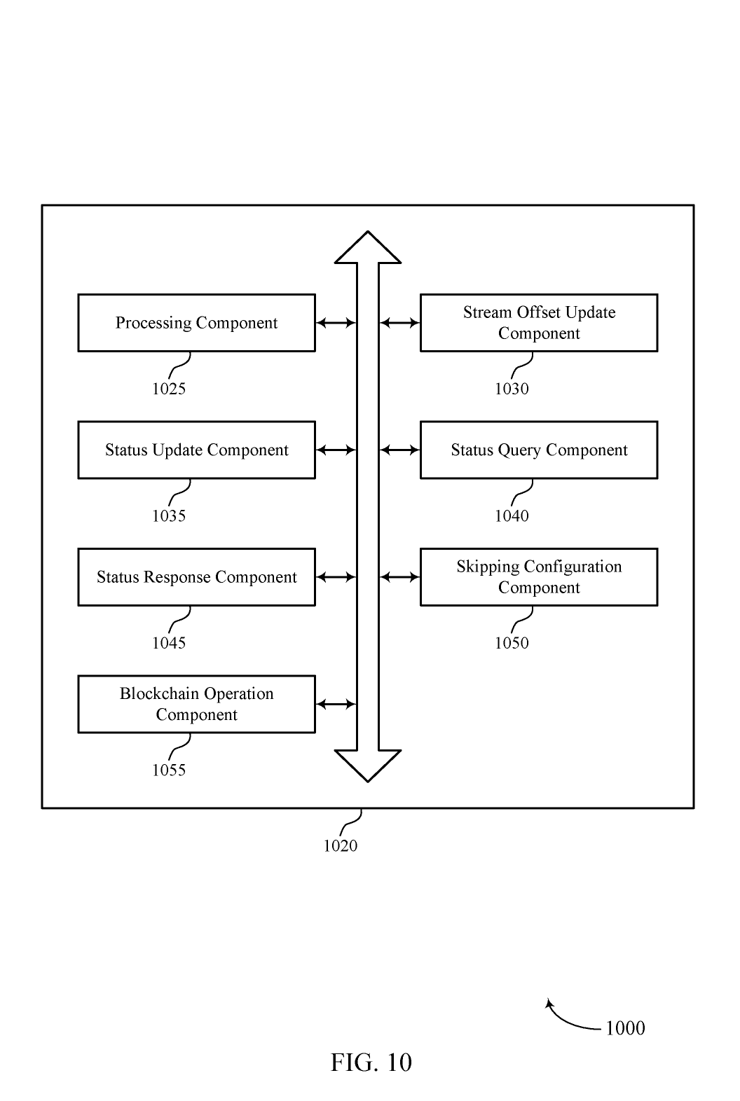

FIG. 10 shows a block diagram 1000 of a DLQ event processor 1020 that supports fault tolerant queue processing with reliable ordering in accordance with aspects of the present disclosure. The DLQ event processor 1020 may be an example of aspects of a DLQ event processor or a DLQ event processor 920, or both, as described herein. The DLQ event processor 1020, or various components thereof, may be an example of means for performing various aspects of fault tolerant queue processing with reliable ordering as described herein. For example, the DLQ event processor 1020 may include a processing component 1025, a stream offset update component 1030, a status update component 1035, a status query component 1040, a status response component 1045, a skipping configuration component 1050, a blockchain operation component 1055, or any combination thereof. Each of these components may communicate, directly or indirectly, with one another (e.g., via one or more buses, communications links, communications interfaces, or any combination thereof).

The processing component 1025 may be configured as or otherwise support a means for attempting to process one or more events in a DLQ, wherein the one or more events are received from a main processor. The stream offset update component 1030 may be configured as or otherwise support a means for updating, after successfully processing an event of the one or more events in the DLQ, a stream offset of an event stream that provides, to the main processor, a stream of events comprising the event, the stream offset updated to correspond to the successfully processed event. The status update component 1035 may be configured as or otherwise support a means for updating a block status associated with an identifier of an account associated with the event that was successfully processed.

In some examples, the status query component 1040 may be configured as or otherwise support a means for receiving, to retrieve the block status associated with the account, a query using the identifier associated with the account, the block status indicating whether events associated with the account are being blocked for processing. In some examples, the status response component 1045 may be configured as or otherwise support a means for transmitting, based at least in part on the identifier, a response to the query including the block status of the account.

In some examples, to support updating the block status, the status update component 1035 may be configured as or otherwise support a means for updating the block status of the identifier from a first status to a second status based at least in part on the updated stream offset corresponding to a current offset at the main processor.

In some examples, the skipping configuration component 1050 may be configured as or otherwise support a means for skipping a second event of the one or more events in the DLQ based at least in part on a configuration that indicates to skip events associated with a second account, the second event being associated with the second account.

In some examples, the event comprises an operation associated with a blockchain address on a blockchain network, and the blockchain operation component 1055 may be configured as or otherwise support a means for broadcasting one or more messages to the blockchain network configured to execute the operation.

In some examples, a plurality of events are received from the event stream that comprises a plurality of partitions. In some examples, each partition is associated with one or more accounts, a respective main processor, and a respective DLQ.

FIG. 11 shows a diagram of a system 1100 including a system 1105 that supports fault tolerant queue processing with reliable ordering in accordance with aspects of the present disclosure. The system 1105 may be an example of or include components of a system 905 as described herein. The system 1105 may include components for bi-directional voice and data communications including components for transmitting and receiving communications, such as a DLQ event processor 1120, an input information 1110, an output information 1115, a network interface 1125, at least one memory 1130, at least one processor 1135, and a storage 1140. Each of these components may communicate, directly or indirectly, with one another (e.g., via one or more buses, communications links, communications interfaces, or any combination thereof).

The network interface 1125 may enable the system 1105 to exchange information (e.g., input information 1110, output information 1115, or both) with other systems or devices (not shown). For example, the network interface 1125 may enable the system 1105 to connect to a network (e.g., a network 135 as described herein). The network interface 1125 may include one or more wireless network interfaces, one or more wired network interfaces, or any combination thereof.

Memory 1130 may include RAM, ROM, or both. The memory 1130 may store computer-readable, computer-executable software including instructions that, when executed, cause at least one processor 1135 to perform various functions described herein, such as functions supporting fault tolerant queue processing with reliable ordering. In some cases, the memory 1130 may contain, among other things, a basic input/output system (BIOS), which may control basic hardware or software operation such as the interaction with peripheral components or devices. In some cases, the memory 1130 may be an example of aspects of one or more components of a custodial token platform 110 as described with reference to FIG. 1. The memory 1130 may be an example of a single memory or multiple memories. For example, the system 1105 may include one or more memories 1130.

The processor 1135 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 1135 may be configured to execute computer-readable instructions stored in at least one memory 1130 to perform various functions (e.g., functions or tasks supporting fault tolerant queue processing with reliable ordering). Though a single processor 1135 is depicted in the example of FIG. 11, it is to be understood that the system 1105 may include any quantity of one or more of processors 1135 and that a group of processors 1135 may collectively perform one or more functions ascribed herein to a processor, such as the processor 1135. The processor 1135 may be an example of a single processor or multiple processors. For example, the system 1105 may include one or more processors 1135.

Storage 1140 may be configured to store data that is generated, processed, stored, or otherwise used by the system 1105. In some cases, the storage 1140 may include one or more HDDs, one or more SDDs, or both. In some examples, the storage 1140 may be an example of a single database, a distributed database, multiple distributed databases, a data store, a data lake, or an emergency backup database. In some examples, the storage 1140 may be an example of one or more components described with reference to FIG. 1.

For example, the DLQ event processor 1120 may be configured as or otherwise support a means for attempting to process one or more events in a DLQ, wherein the one or more events are received from a main processor. The DLQ event processor 1120 may be configured as or otherwise support a means for updating, after successfully processing an event of the one or more events in the DLQ, a stream offset of an event stream that provides, to the main processor, a stream of events comprising the event, the stream offset updated to correspond to the successfully processed event. The DLQ event processor 1120 may be configured as or otherwise support a means for updating a block status associated with an identifier of an account associated with the event that was successfully processed.

By including or configuring the DLQ event processor 1120 in accordance with examples as described herein, the system 1105 may support techniques for reduced latency associated with event processing while maintaining event ordering.

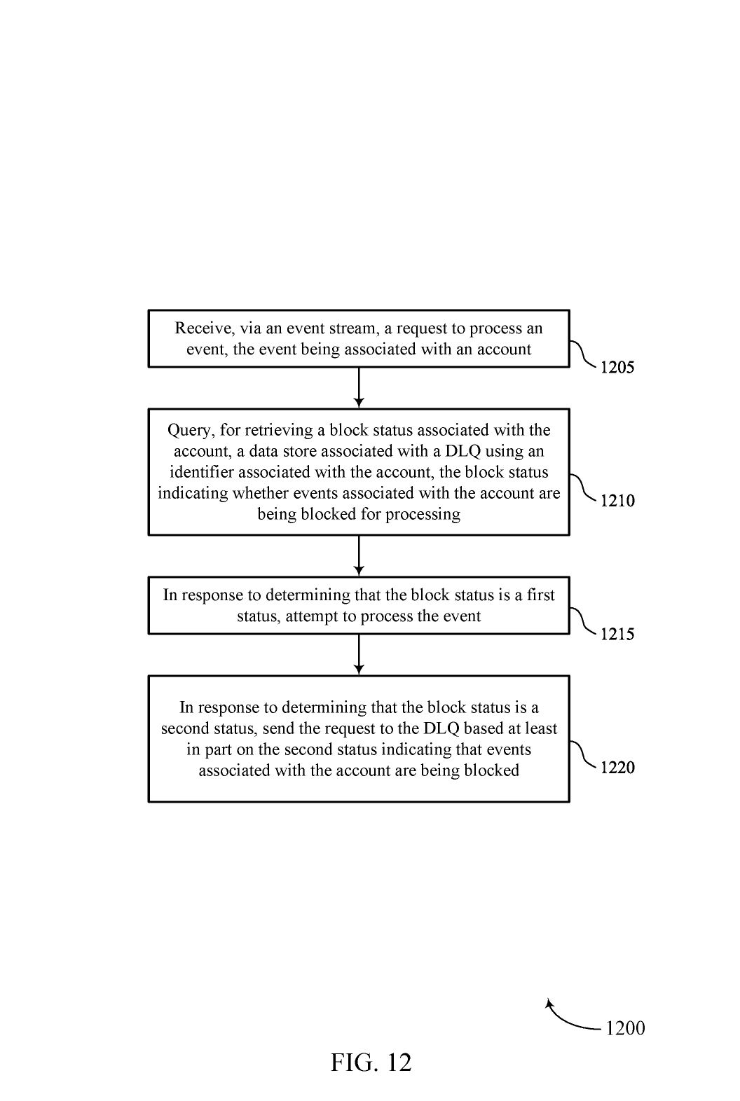

FIG. 12 shows a flowchart illustrating a method 1200 that supports fault tolerant queue processing with reliable ordering in accordance with aspects of the present disclosure. The operations of the method 1200 may be implemented by a main processing component or its components as described herein. For example, the operations of the method 1200 may be performed by a main processing component as described with reference to FIGS. 1 through 8. In some examples, a main processing component may execute a set of instructions to control the functional elements of the main processing component to perform the described functions. Additionally, or alternatively, the main processing component may perform aspects of the described functions using special-purpose hardware.

At 1205, the method may include receiving, via an event stream, a request to process an event, the event being associated with an account. The operations of 1205 may be performed in accordance with examples as disclosed herein. In some examples, aspects of the operations of 1205 may be performed by a request component 725 as described with reference to FIG. 7.

At 1210, the method may include querying, for retrieving a block status associated with the account, a data store associated with a DLQ using an identifier associated with the account, the block status indicating whether events associated with the account are being blocked for processing. The operations of 1210 may be performed in accordance with examples as disclosed herein. In some examples, aspects of the operations of 1210 may be performed by a status query component 730 as described with reference to FIG. 7.

At 1215, the method may include in response to determining that the block status is a first status, attempting to process the event. The operations of 1215 may be performed in accordance with examples as disclosed herein. In some examples, aspects of the operations of 1215 may be performed by a processing component 735 as described with reference to FIG. 7.

At 1220, the method may include in response to determining that the block status is a second status, sending the request to the DLQ based at least in part on the second status indicating that events associated with the account are being blocked. The operations of 1220 may be performed in accordance with examples as disclosed herein. In some examples, aspects of the operations of 1220 may be performed by a DLQ relocation component 740 as described with reference to FIG. 7.

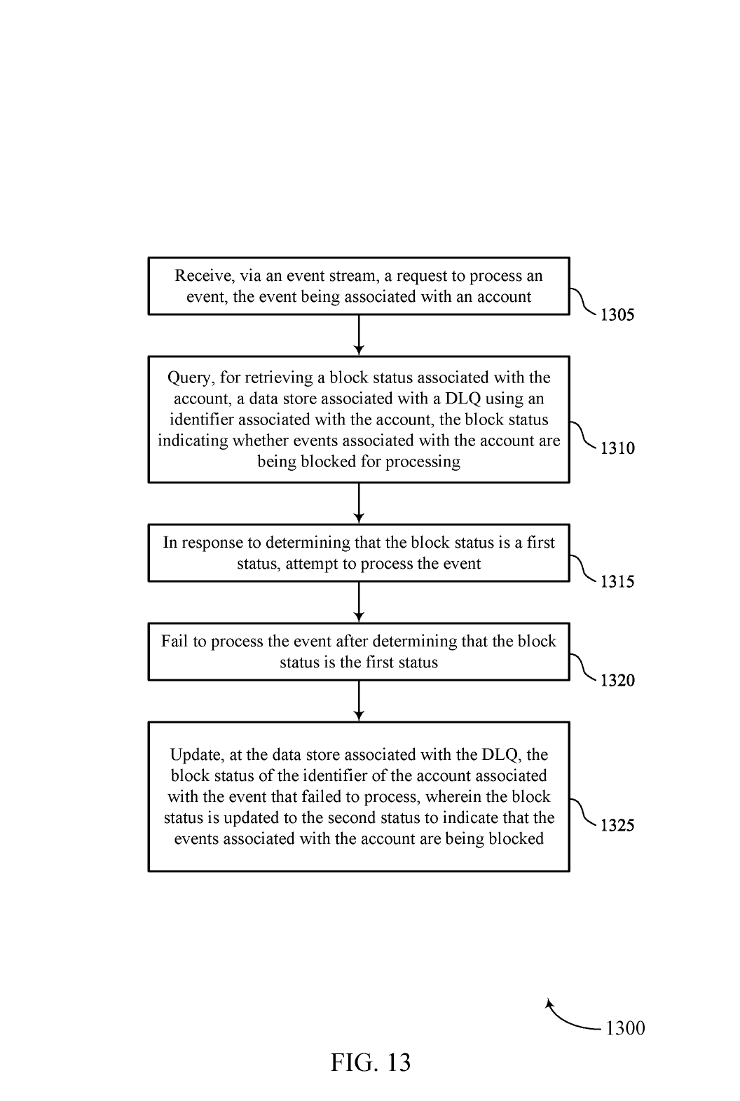

FIG. 13 shows a flowchart illustrating a method 1300 that supports fault tolerant queue processing with reliable ordering in accordance with aspects of the present disclosure. The operations of the method 1300 may be implemented by a main processing component or its components as described herein. For example, the operations of the method 1300 may be performed by a main processing component as described with reference to FIGS. 1 through 8. In some examples, a main processing component may execute a set of instructions to control the functional elements of the main processing component to perform the described functions. Additionally, or alternatively, the main processing component may perform aspects of the described functions using special-purpose hardware.

At 1305, the method may include receiving, via an event stream, a request to process an event, the event being associated with an account. The operations of 1305 may be performed in accordance with examples as disclosed herein. In some examples, aspects of the operations of 1305 may be performed by a request component 725 as described with reference to FIG. 7.

At 1310, the method may include querying, for retrieving a block status associated with the account, a data store associated with a DLQ using an identifier associated with the account, the block status indicating whether events associated with the account are being blocked for processing. The operations of 1310 may be performed in accordance with examples as disclosed herein. In some examples, aspects of the operations of 1310 may be performed by a status query component 730 as described with reference to FIG. 7.

At 1315, the method may include in response to determining that the block status is a first status, attempting to process the event. The operations of 1315 may be performed in accordance with examples as disclosed herein. In some examples, aspects of the operations of 1315 may be performed by a processing component 735 as described with reference to FIG. 7.

At 1320, the method may include failing to process the event after determining that the block status is the first status. The operations of 1320 may be performed in accordance with examples as disclosed herein. In some examples, aspects of the operations of 1320 may be performed by a processing component 735 as described with reference to FIG. 7.

At 1325, the method may include updating, at the data store associated with the DLQ, the block status of the identifier of the account associated with the event that failed to process, wherein the block status is updated to the second status to indicate that the events associated with the account are being blocked. The operations of 1325 may be performed in accordance with examples as disclosed herein. In some examples, aspects of the operations of 1325 may be performed by a status update component 745 as described with reference to FIG. 7.

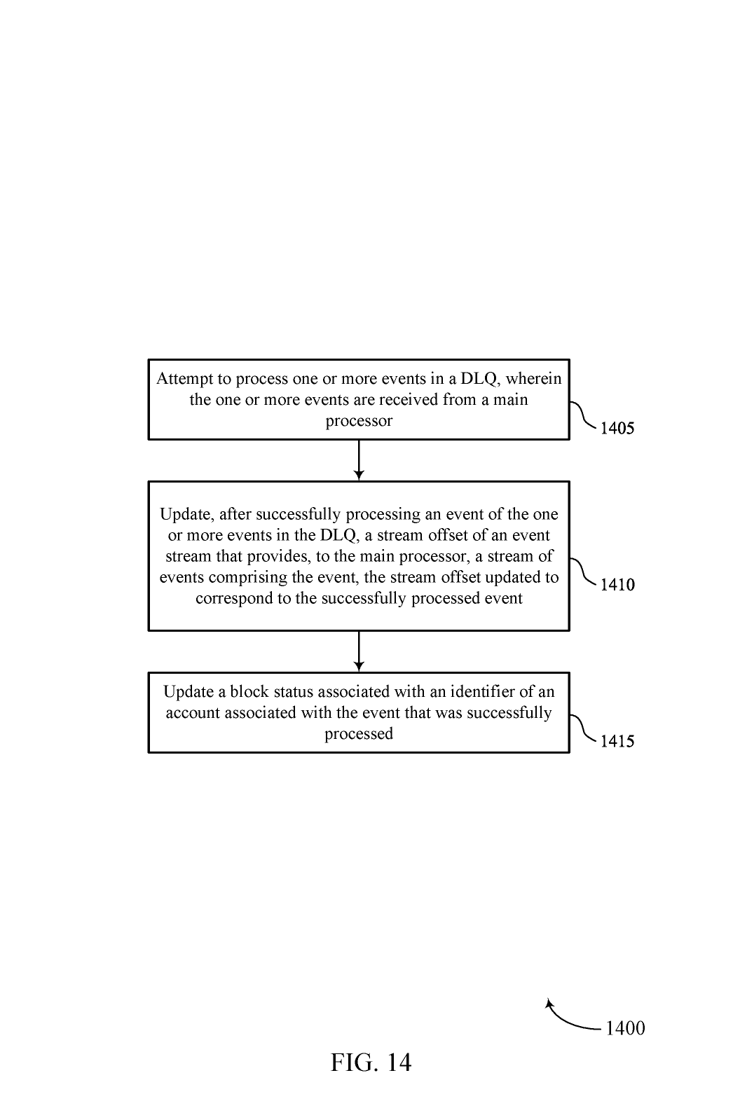

FIG. 14 shows a flowchart illustrating a method 1400 that supports fault tolerant queue processing with reliable ordering in accordance with aspects of the present disclosure. The operations of the method 1400 may be implemented by a DLQ processing component or its components as described herein. For example, the operations of the method 1400 may be performed by a DLQ processing component as described with reference to FIGS. 1 through 5 and 9 through 11. In some examples, a DLQ processing component may execute a set of instructions to control the functional elements of the DLQ processing component to perform the described functions. Additionally, or alternatively, the DLQ processing component may perform aspects of the described functions using special-purpose hardware.

At 1405, the method may include attempting to process one or more events in a DLQ, wherein the one or more events are received from a main processor. The operations of 1405 may be performed in accordance with examples as disclosed herein. In some examples, aspects of the operations of 1405 may be performed by a processing component 1025 as described with reference to FIG. 10.

At 1410, the method may include updating, after successfully processing an event of the one or more events in the DLQ, a stream offset of an event stream that provides, to the main processor, a stream of events comprising the event, the stream offset updated to correspond to the successfully processed event. The operations of 1410 may be performed in accordance with examples as disclosed herein. In some examples, aspects of the operations of 1410 may be performed by a stream offset update component 1030 as described with reference to FIG. 10.

At 1415, the method may include updating a block status associated with an identifier of an account associated with the event that was successfully processed. The operations of 1415 may be performed in accordance with examples as disclosed herein. In some examples, aspects of the operations of 1415 may be performed by a status update component 1035 as described with reference to FIG. 10.

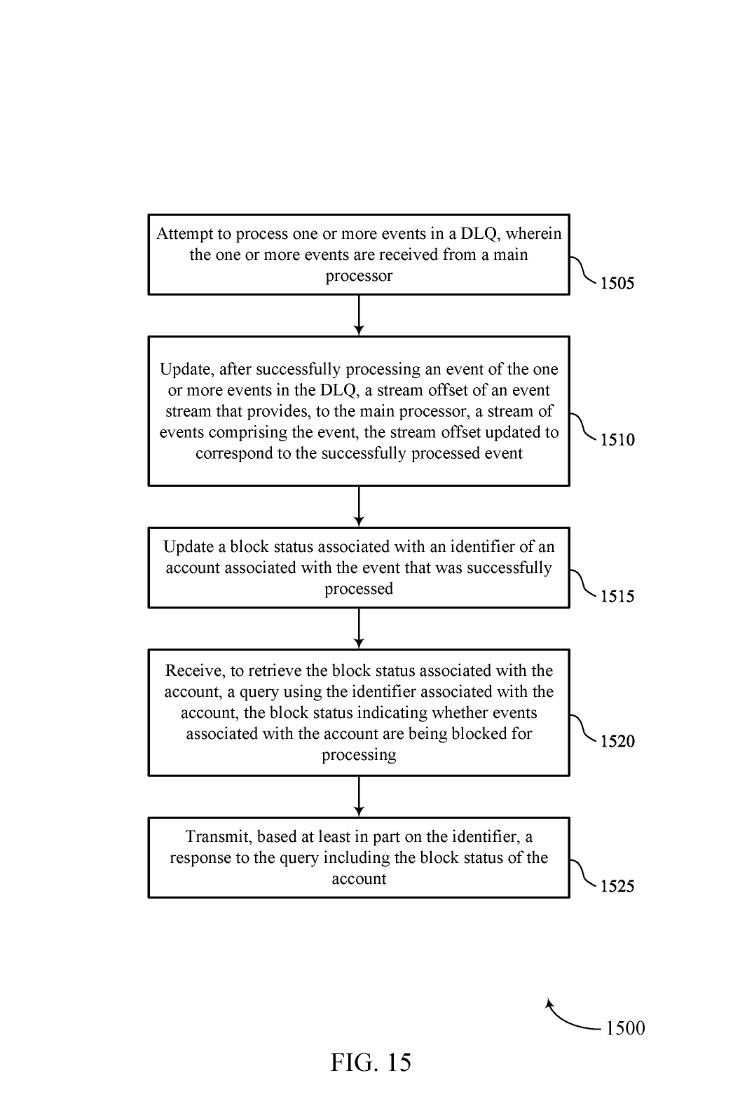

FIG. 15 shows a flowchart illustrating a method 1500 that supports fault tolerant queue processing with reliable ordering in accordance with aspects of the present disclosure. The operations of the method 1500 may be implemented by a DLQ processing component or its components as described herein. For example, the operations of the method 1500 may be performed by a DLQ processing component as described with reference to FIGS. 1 through 5 and 9 through 11. In some examples, a DLQ processing component may execute a set of instructions to control the functional elements of the DLQ processing component to perform the described functions. Additionally, or alternatively, the DLQ processing component may perform aspects of the described functions using special-purpose hardware.

At 1505, the method may include attempting to process one or more events in a DLQ, wherein the one or more events are received from a main processor. The operations of 1505 may be performed in accordance with examples as disclosed herein. In some examples, aspects of the operations of 1505 may be performed by a processing component 1025 as described with reference to FIG. 10.

At 1510, the method may include updating, after successfully processing an event of the one or more events in the DLQ, a stream offset of an event stream that provides, to the main processor, a stream of events comprising the event, the stream offset updated to correspond to the successfully processed event. The operations of 1510 may be performed in accordance with examples as disclosed herein. In some examples, aspects of the operations of 1510 may be performed by a stream offset update component 1030 as described with reference to FIG. 10.

At 1515, the method may include updating a block status associated with an identifier of an account associated with the event that was successfully processed. The operations of 1515 may be performed in accordance with examples as disclosed herein. In some examples, aspects of the operations of 1515 may be performed by a status update component 1035 as described with reference to FIG. 10.

At 1520, the method may include receiving, to retrieve the block status associated with the account, a query using the identifier associated with the account, the block status indicating whether events associated with the account are being blocked for processing. The operations of 1520 may be performed in accordance with examples as disclosed herein. In some examples, aspects of the operations of 1520 may be performed by a status query component 1040 as described with reference to FIG. 10.

At 1525, the method may include transmitting, based at least in part on the identifier, a response to the query including the block status of the account. The operations of 1525 may be performed in accordance with examples as disclosed herein. In some examples, aspects of the operations of 1525 may be performed by a status response component 1045 as described with reference to FIG. 10.

A method by an apparatus is described. The method may include receiving, via an event stream, a request to process an event, the event being associated with an account, querying, for retrieving a block status associated with the account, a data store associated with a DLQ using an identifier associated with the account, the block status indicating whether events associated with the account are being blocked for processing, in response to determining that the block status is a first status, attempting to process the event, and in response to determining that the block status is a second status, sending the request to the DLQ based at least in part on the second status indicating that events associated with the account are being blocked.

An apparatus is described. The apparatus may include one or more memories storing processor executable code, and one or more processors coupled with the one or more memories. The one or more processors may individually or collectively be operable to execute the code to cause the apparatus to receive, via an event stream, a request to process an event, the event being associated with an account, query, for retrieving a block status associated with the account, a data store associated with a DLQ using an identifier associated with the account, the block status indicating whether events associated with the account are being blocked for processing, in response to determining that the block status is a first status, attempting to process the event, and in response to determining that the block status is a second status, sending the request to the DLQ based at least in part on the second status indicating that events associated with the account are being blocked.

Another apparatus is described. The apparatus may include means for receiving, via an event stream, a request to process an event, the event being associated with an account, means for querying, for retrieving a block status associated with the account, a data store associated with a DLQ using an identifier associated with the account, the block status indicating whether events associated with the account are being blocked for processing, means for in response to determining that the block status is a first status, attempting to process the event, and means for in response to determining that the block status is a second status, sending the request to the DLQ based at least in part on the second status indicating that events associated with the account are being blocked.

A non-transitory computer-readable medium storing code is described. The code may include instructions executable by one or more processors to receive, via an event stream, a request to process an event, the event being associated with an account, query, for retrieving a block status associated with the account, a data store associated with a DLQ using an identifier associated with the account, the block status indicating whether events associated with the account are being blocked for processing, in response to determining that the block status is a first status, attempting to process the event, and in response to determining that the block status is a second status, sending the request to the DLQ based at least in part on the second status indicating that events associated with the account are being blocked.

Some examples of the method, apparatus, and non-transitory computer-readable medium described herein may further include operations, features, means, or instructions for failing to process the event after determining that the block status may be the first status and updating, at the data store associated with the DLQ, the block status of the identifier of the account associated with the event that failed to process, wherein the block status may be updated to the second status to indicate that the events associated with the account may be being blocked.

In some examples of the method, apparatus, and non-transitory computer-readable medium described herein, the block status may be updated after failure of a threshold quantity of processing attempts.

Some examples of the method, apparatus, and non-transitory computer-readable medium described herein may further include operations, features, means, or instructions for updating, after failing to process the event, a stream offset of the event stream to correspond to the event.

Some examples of the method, apparatus, and non-transitory computer-readable medium described herein may further include operations, features, means, or instructions for receiving, after sending the request to the DLQ, a second request to process a second event, the second event being associated with a second account and in response to determining that a second block status of the second account may be the first status, processing the second event.

In some examples of the method, apparatus, and non-transitory computer-readable medium described herein, the event comprises an operation associated with a blockchain address on a blockchain network and the method, apparatuses, and non-transitory computer-readable medium may include further operations, features, means, or instructions for broadcasting one or more messages to the blockchain network configured to execute the operation.

In some examples of the method, apparatus, and non-transitory computer-readable medium described herein, a plurality of events may be received from the event stream that comprises a plurality of partitions, each partition associated with one or more accounts, a respective main processor, and a respective DLQ.

A method by an apparatus is described. The method may include attempting to process one or more events in a DLQ, wherein the one or more events are received from a main processor, updating, after successfully processing an event of the one or more events in the DLQ, a stream offset of an event stream that provides, to the main processor, a stream of events comprising the event, the stream offset updated to correspond to the successfully processed event, and updating a block status associated with an identifier of an account associated with the event that was successfully processed.

An apparatus is described. The apparatus may include one or more memories storing processor executable code, and one or more processors coupled with the one or more memories. The one or more processors may individually or collectively be operable to execute the code to cause the apparatus to attempt to process one or more events in a DLQ, wherein the one or more events are received from a main processor, update, after successfully processing an event of the one or more events in the DLQ, a stream offset of an event stream that provides, to the main processor, a stream of events comprising the event, the stream offset updated to correspond to the successfully processed event, and update a block status associated with an identifier of an account associated with the event that was successfully processed.

Another apparatus is described. The apparatus may include means for attempting to process one or more events in a DLQ, wherein the one or more events are received from a main processor, means for updating, after successfully processing an event of the one or more events in the DLQ, a stream offset of an event stream that provides, to the main processor, a stream of events comprising the event, the stream offset updated to correspond to the successfully processed event, and means for updating a block status associated with an identifier of an account associated with the event that was successfully processed.

A non-transitory computer-readable medium storing code is described. The code may include instructions executable by one or more processors to attempt to process one or more events in a DLQ, wherein the one or more events are received from a main processor, update, after successfully processing an event of the one or more events in the DLQ, a stream offset of an event stream that provides, to the main processor, a stream of events comprising the event, the stream offset updated to correspond to the successfully processed event, and update a block status associated with an identifier of an account associated with the event that was successfully processed.

Some examples of the method, apparatus, and non-transitory computer-readable medium described herein may further include operations, features, means, or instructions for receiving, to retrieve the block status associated with the account, a query using the identifier associated with the account, the block status indicating whether events associated with the account may be being blocked for processing and transmitting, based at least in part on the identifier, a response to the query including the block status of the account.

In some examples of the method, apparatus, and non-transitory computer-readable medium described herein, updating the block status may include operations, features, means, or instructions for updating the block status of the identifier from a first status to a second status based at least in part on the updated stream offset corresponding to a current offset at the main processor.

Some examples of the method, apparatus, and non-transitory computer-readable medium described herein may further include operations, features, means, or instructions for skipping a second event of the one or more events in the DLQ based at least in part on a configuration that indicates to skip events associated with a second account, the second event being associated with the second account.

In some examples of the method, apparatus, and non-transitory computer-readable medium described herein, the event comprises an operation associated with a blockchain address on a blockchain network and the method, apparatuses, and non-transitory computer-readable medium may include further operations, features, means, or instructions for broadcasting one or more messages to the blockchain network configured to execute the operation.

In some examples of the method, apparatus, and non-transitory computer-readable medium described herein, a plurality of events may be received from the event stream that comprises a plurality of partitions and each partition may be associated with one or more accounts, a respective main processor, and a respective DLQ.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method of queue management, comprising:
receiving, via an event stream, a request to process an event, the event being associated with an account;
querying, for retrieving a block status associated with the account, a data store associated with a dead letter queue using an identifier associated with the account, the block status indicating whether events associated with the account are being blocked for processing;
in response to determining that the block status is a first status, attempting to process the event; and
in response to determining that the block status is a second status, sending the request to the dead letter queue based at least in part on the second status indicating that events associated with the account are being blocked.

2. The method of claim 1, further comprising:
failing to process the event after determining that the block status is the first status; and
updating, at the data store associated with the dead letter queue, the block status of the identifier of the account associated with the event that failed to process, wherein the block status is updated to the second status to indicate that the events associated with the account are being blocked.

3. The method of claim 2, wherein the block status is updated after failure of a threshold quantity of processing attempts.

4. The method of claim 2, further comprising:
updating, after failing to process the event, a stream offset of the event stream to correspond to the event.

5. The method of claim 1, further comprising:
receiving, after sending the request to the dead letter queue, a second request to process a second event, the second event being associated with a second account; and
in response to determining that a second block status of the second account is the first status, processing the second event.

6. The method of claim 1, wherein the event comprises an operation associated with a blockchain address on a blockchain network, and wherein, to process the operation, the method further comprises:
broadcasting one or more messages to the blockchain network configured to execute the operation.

7. The method of claim 1, wherein a plurality of events are received from the event stream that comprises a plurality of partitions, each partition associated with one or more accounts, a respective main processor, and a respective dead letter queue.

8. A method of queue management, comprising:
attempting to process one or more events in a dead letter queue, wherein the one or more events are received from a main processor;
updating, after successfully processing an event of the one or more events in the dead letter queue, a stream offset of an event stream that provides, to the main processor, a stream of events comprising the event, the stream offset updated to correspond to the successfully processed event; and
updating a block status associated with an identifier of an account associated with the event that was successfully processed.

9. The method of claim 8, further comprising:
receiving, to retrieve the block status associated with the account, a query using the identifier associated with the account, the block status indicating whether events associated with the account are being blocked for processing; and
transmitting, based at least in part on the identifier, a response to the query including the block status of the account.

10. The method of claim 8, wherein updating the block status comprises:
updating the block status of the identifier from a first status to a second status based at least in part on the updated stream offset corresponding to a current offset at the main processor.

11. The method of claim 8, further comprising:
skipping a second event of the one or more events in the dead letter queue based at least in part on a configuration that indicates to skip events associated with a second account, the second event being associated with the second account.

12. The method of claim 8, wherein the event comprises an operation associated with a blockchain address on a blockchain network, and wherein, to process the operation, the method further comprises:
broadcasting one or more messages to the blockchain network configured to execute the operation.

13. The method of claim 8, wherein a plurality of events are received from the event stream that comprises a plurality of partitions, and wherein each partition is associated with one or more accounts, a respective main processor, and a respective dead letter queue.

14. An apparatus, comprising:
one or more memories storing processor-executable code; and
one or more processors coupled with the one or more memories and individually or collectively operable to execute the code to cause the apparatus to:
receive, via an event stream, a request to process an event, the event being associated with an account;
query, for retrieving a block status associated with the account, a data store associated with a dead letter queue using an identifier associated with the account, the block status indicating whether events associated with the account are being blocked for processing;
in response to determining that the block status is a first status, attempt to process the event; and
in response to determining that the block status is a second status, send the request to the dead letter queue based at least in part on the second status indicating that events associated with the account are being blocked.

15. The apparatus of claim 14, wherein the one or more processors are individually or collectively further operable to execute the code to cause the apparatus to:
fail to process the event after determining that the block status is the first status; and
update, at the data store associated with the dead letter queue, the block status of the identifier of the account associated with the event that failed to process, wherein the block status is updated to the second status to indicate that the events associated with the account are being blocked.

16. The apparatus of claim 15, wherein the block status is updated after failure of a threshold quantity of processing attempts.

17. The apparatus of claim 15, wherein the one or more processors are individually or collectively further operable to execute the code to cause the apparatus to:
update, after failing to process the event, a stream offset of the event stream to correspond to the event.

18. The apparatus of claim 14, wherein the one or more processors are individually or collectively further operable to execute the code to cause the apparatus to:
receive, after sending the request to the dead letter queue, a second request to process a second event, the second event being associated with a second account; and
in response to determining that a second block status of the second account is the first status, processing the second event.

19. The apparatus of claim 14, wherein the event comprises an operation associated with a blockchain address on a blockchain network, and the one or more processors are individually or collectively further operable to execute the code to cause the apparatus to:
broadcast one or more messages to the blockchain network configured to execute the operation.

20. The apparatus of claim 14, wherein a plurality of events are received from the event stream that comprises a plurality of partitions, each partition associated with one or more accounts, a respective main processor, and a respective dead letter queue.
